(19) United States
(12) Patent Application Publication
(10) Pub. No.: US 2015/0324635 A1
(43) Pub. Date: Nov. 12, 2015

(54) METHODS, SYSTEMS, AND APPARATUSES FOR VISITOR MONITORING

(71) Applicant: Eye Stalks Corporation DBA Bay Sensors, Palo Alto, CA (US)

(72) Inventors: Greg Lin Tanaka, Palo Alto, CA (US); Mainak Sen, Palo Alto, CA (US); Kyle Howard Heath, Menlo Park, CA (US)

(21) Appl. No.: 14/699,994

(22) Filed: Apr. 29, 2015

Related U.S. Application Data
(60) Provisional application No. 61/986,672, filed on Apr. 30, 2014.
(60) Provisional application No. 61/987,226, filed on May 1, 2014.

(51) Int. Cl. G06K 9/00; G06Q 40/00; H04N 7/18; G06F 3/041; H04N 5/232; G06K 19/077

(52) U.S. Cl. CPC G06K 9/00335; H04N 5/23241; G06K 19/07749; H04N 7/18; G06F 3/041; G06Q 40/00; G06F 2203/04101

(57) ABSTRACT

A system for automatic visitor monitoring comprises one or more sensors and a processor. The one or more sensors can be configured to automatically generate electronic sensor data regarding visitors at a venue. The processor can be configured to process the electronic sensor data to identify one or more visitors. The processor can also be configured to identify one or more characteristics of the behavior of the one or more visitors or devices carried by said visitors. Even further, the processor can be configured to determine if two or more visitors are part of a single visitor group unit.

### PRIORITY INFORMATION

This application claims priority benefit under 35 U.S.C. §119(e) to U.S. Provisional Patent Application Ser. No. 61/986,672, filed 30 Apr. 2014 and entitled METHODS, SYSTEMS, AND APPARATUSES FOR VISITOR MONITORING; and U.S. Provisional Patent Application Ser. No. 61/987,226, filed 1 May 2015 and entitled METHODS, SYSTEMS, AND APPARATUSES FOR VISITOR MONITORING, the entirety of each hereby expressly incorporated by reference herein.

### BACKGROUND OF THE INVENTIONS

1. Field of the Inventions

Embodiments disclosed herein are related to communication devices, and more particularly to apparatuses and methods for visitor monitoring.

2. Description of the Related Art

To best service their visitors, venues might consider gathering information about their visitors. This information can be used for a wide variety of ways to improve service, inventory management, profitability, and other aspects important to businesses.

### SUMMARY OF THE INVENTIONS

In one embodiment, a system for automatic visitor monitoring comprises one or more sensors and a processor. The one or more sensors can be configured to automatically generate electronic sensor data regarding visitors at a venue. The processor can be configured to process the electronic sensor data to identify one or more visitors. The processor can also be configured to identify one or more characteristics of the behavior of the one or more visitors or devices carried by said visitors. Even further, the processor can be configured to determine if two or more visitors are part of a single visitor group unit.

In a further embodiment, a system for automatic visitor monitoring and grouping of individuals comprises one or more electronic sensors, a server, and a processor. One or more sensors can be configured to automatically generate electronic sensor data regarding visitors at a venue. The processor can be configured to identify the physical presence and to identify behavioral characteristics of one or more visitors at a venue. The processor also can be configured to identify characteristics of one or more electronic devices carried by one or more visitors. Even further, the processor can be configured to identify if two or more visitors arrive at the same time, or to identify if two or more visitors are within sufficient physical proximity to determine if the visitors are part of a single group unit. In one embodiment, the electronic sensor may comprise a camera. In another embodiment, the electronic sensor may comprise a Wi-Fi antenna. The processor may be configured to search over Wi-Fi for the same SSID to determine whether mobile electronic devices are part of the same group unit. The processor also may be configured to identify a visitor based on an image, a MAC address, payment information, or a visitor's name. The processor may comprise a memory that stores identifying information of a visitor or visitor group. Additionally, the server may comprise one or more networked computers at one or more locations. The server may be configured to store data generated from the electronic sensors.

In a further embodiment, a method for automatically monitoring visitors at a venue can be provided. Electronic sensor data regarding visitors at a venue can be automatically generated. The electronic sensor data can be processed to identify one or more visitors at the venue. Further, one or more characteristics of the behavior of the visitors or devices carried by the visitors can be analyzed to determine if two or more of said visitors are part of a single visitor group unit.

In a further embodiment, a method is provided for automatically monitoring and grouping individuals at a venue. Electronic sensor data related to visitors can be automatically generated. The electronic sensor data can be processed to identify the physical presence of one or more visitors at a venue, or to identify the presence of substantially all visitors at a venue. Further, one or more behavioral characteristics of the visitors or mobile electronic devices carried by the visitors can be analyzed to determine if two or more individuals are part of a single group unit; this step may comprise determining whether two or more individuals arrive at the same time. One method by which visitors may be monitored comprises monitoring Wi-Fi signals from two or more mobile electronic devices, or may comprise identifying two or more mobile electronic devices that search over Wi-Fi for the same SSID. Further, the MAC address for a specific mobile electronic device can be associated with its respective owner; this information may be stored. Further, the payment information of two or more visitors identified as part of single group unit may be stored. The electronic sensor data may comprise one or more electronic images. These images may be analyzed to determine whether two or more visitors within sufficiently close physical proximity are part of a single group unit, and these images may be stored.

In a further embodiment, a method of developing a system to identify humans and human behavior is provided. A large number of images or videos can be collected, a plurality of said images including one or more people. The images or videos can be used as an internet Completely Automated Public Turing Test to tell Computers and Humans Apart (“CAPTCHA”), requiring human testers to identify at least one of if a person is in the image or video, if a person is in the image or video at a particular place, or if a person in the image or video is performing a particular action. Responses from said Internet CAPTCHA can then be used to train a machine learning algorithm to identify the at least one of if a person is in the image or video, if a person is in the image or video at a particular place, or if a person in the image or video is performing a particular action.

In a further embodiment, a method for analyzing images to identify individual visitors is provided. A large number of electronically-generated images or videos can be collected, a plurality of said images including one or more people. The images or videos may be used as a CAPTCHA, requiring human testers to identify if at least one person is present is in the image or video, if a person is located at a particular location, or if a person is performing a particular action. Responses from said Internet CAPTCHAs can then be used to train an adaptive computer program product to identify if at least one person is present in the image or video, if a person is located at a particular location, or if a person is performing a particular action.

In a further embodiment, a smart label system can comprise a plurality of products disposed in a retail space, a plurality of smart labels, and a server. The plurality of smart labels can be disposed in close physical proximity to associated products such that a specific smart label can provide information to a visitor about the specific product in close physical proximity. Further, the smart labels can comprise an electronic screen configured to provide visual information to a visitor. The smart labels can also comprise a processor configured to update information provided on the electronic screen. The server can be in electronic communication with the plurality of smart labels and configured to communicate with the processors to control the smart labels.

In a further embodiment, a smart label system can comprise a plurality of products disposed in a retail space, a plurality of smart labels, a display, and a processor. The plurality of smart labels may be arranged in close physical proximity to associated products such that a specific smart label can provide information to a visitor about a specific product with which it is in close physical proximity. Further, the smart labels can comprise a display configured to provide visual information to a visitor. Even further, the smart labels can also comprise a processor configured to update information presented on the display and communicate with a server configured to communicate with and control the smart labels. Further, the server may comprise one or more networked computers at one or more locations. Even further, the server and at least one smart label may be configured to detect if a product is in planogram compliance. In one embodiment, the display may comprise a touch screen. Further, the smart labels may be configured to provide a user interface such that a visitor can cause different information to appear on the display by touching the screen. In another embodiment, the smart labels may comprise a speaker that relays audio information to a visitor. Further, the smart labels may comprise a microphone capable of receiving voice commands and displaying relevant information in response to voice commands. In another embodiment, the smart labels may comprise a Wi-Fi antenna. In another embodiment, the smart labels may comprise one or more electronic sensors configured to identify a visitor and display different information in response to a visitor remaining in close physical proximity to the sensors for an extended time period. In another embodiment, the smart labels may comprise a camera. The camera may be configured to monitor the inventory of a particular product, or a product located on the opposite side of an aisle relative to the smart label's position. Further, the smart labels may be configured to scan a barcode or other portion of a product to identify the product or to relay product information.

In a further embodiment, a method for identifying multiple aspects of a single visitor can be provided. An image of a visitor using a camera can be acquired and a known position and orientation of the camera can be used to identify a location of the visitor at the time of the image. Further, at least one other electronic sensor can be used to identify a visitor at the same position and time as the image. The image and data from the at least one other electronic sensor can then be associated in an electronic database of visitors.

In a further embodiment, a method for identifying multiple aspects of a single visitor is provided and comprises a camera, the camera's orientation, at least one other electronic sensor, and another image in an electronic database of visitor images. The camera may be used to generate an electronic image of the visitor. The location of a visitor at the time an image is generated may be determined based at least in part on the camera's position and orientation. At least one other electronic sensor may be used to verify a visitor's presence at the same location and time as the image is generated. The image and data generated from at least one other electronic sensor may be associated with another image in an electronic database of visitor images. In one embodiment, at least one electronic sensor may comprise a Wi-Fi antenna, enabling the location of the visitor to be detected from the individual's mobile electronic device. Further, the MAC address of a specific mobile electronic device can be identified using at least one electronic sensor. Even further, at least one electronic sensor may comprise a payment information device that may verify a visitor's presence and may identify a visitor's location by associating the payment information with a visitor's image. The payment information device may comprise a credit or debit card payment device; the information may include a credit card number. The payment information may be stored securely in the form of a cryptographic hash.

In a further embodiment, a visitor monitoring device comprises a chipset, a housing, a camera, a Wi-Fi module, and a track light mounting. The chipset can be disposed in the housing and the camera can be attached to the housing and configured to view one or more visitors in a venue. The Wi-Fi module also can be disposed within the housing and also be configured to communicate wirelessly with a server. The track light mounting can be configured to attach the housing to a track light fixture.

In a further embodiment, a power-harvesting device comprises a chipset, disposed in a housing, a camera attached to the housing, a Wi-Fi module, and a track light mounting. The chipset can be disposed in the housing and the camera can be attached to the housing and configured to view one or more visitors in a venue. The Wi-Fi module also can be disposed within the housing and also be configured to communicate wirelessly with a server. The track light mounting can be configured to attach the housing to a track light fixture.

### BRIEF DESCRIPTION OF THE DRAWINGS

FIG. 1A is a block diagram of a device for visual monitoring according to one embodiment.

FIG. 1B is a block diagram of a device for visual monitoring according to another embodiment.

FIGS. 1C and 1D are schematic drawings of a device for visual monitoring according to one embodiment.

FIG. 1E is a schematic drawing of a device for visual monitoring and its placement according to one embodiment.

FIG. 2 is a schematic drawing of a device for visual monitoring according to another embodiment.

FIG. 3 is a block diagram of a field-programmable gate array (FPGA) chip in a device for visual monitoring according to one embodiment.

FIGS. 4A-4C are schematic diagrams of devices for visual monitoring and their placements according to embodiments.

FIG. 5A is a block diagram of a packet-based network communicatively coupled to a device for visual monitoring according to one embodiment.

FIGS. 5B and 5C are block diagrams illustrating a software stack in a device for visual monitoring and software engines in the packet-based network according to embodiments.

FIG. 6A is a flowchart illustrating a method for visual monitoring according to embodiments.

FIG. 6B is a schematic diagram illustrating images taken by a device for visual monitoring according to embodiments.

FIGS. 7A and 7B are flowcharts illustrating methods for visual monitoring performed by a device for visual monitoring and by a server, respectively, according to embodiments.

FIG. 7C illustrates a software stack at a server with which a device for visual monitoring is communicating according to embodiments.

FIG. 8 is a flowchart illustrating a method for software updating at a device for visual monitoring according to an embodiment.

FIG. 9 is a flow chart illustrating a method for Wi-Fi hookup at a device for visual monitoring according to an embodiment.

FIG. 10 is a flow chart illustrating a method for providing hotspot service at a device for visual monitoring according to an embodiment.

FIG. 11 is a block diagram of a software stack at a device for visual monitoring according to an embodiment.

FIG. 12A is a schematic diagram of a field of view of a device for visual monitoring and trip lines defined in the field of view according to an embodiment.

FIG. 12B is a schematic diagram of a trip line image according to an embodiment.

FIG. 12C is an exemplary trip line image.

FIGS. 13A-13C illustrate embodiments of a device for visual monitoring also used as a smart label.

FIG. 14 illustrates another embodiment of a device for visual monitoring also used as a smart label.

FIGS. 15 and 16 illustrate an embodiment device for visual monitoring mounted to a track light fixture.

### DETAILED DESCRIPTION OF PREFERRED EMBODIMENTS

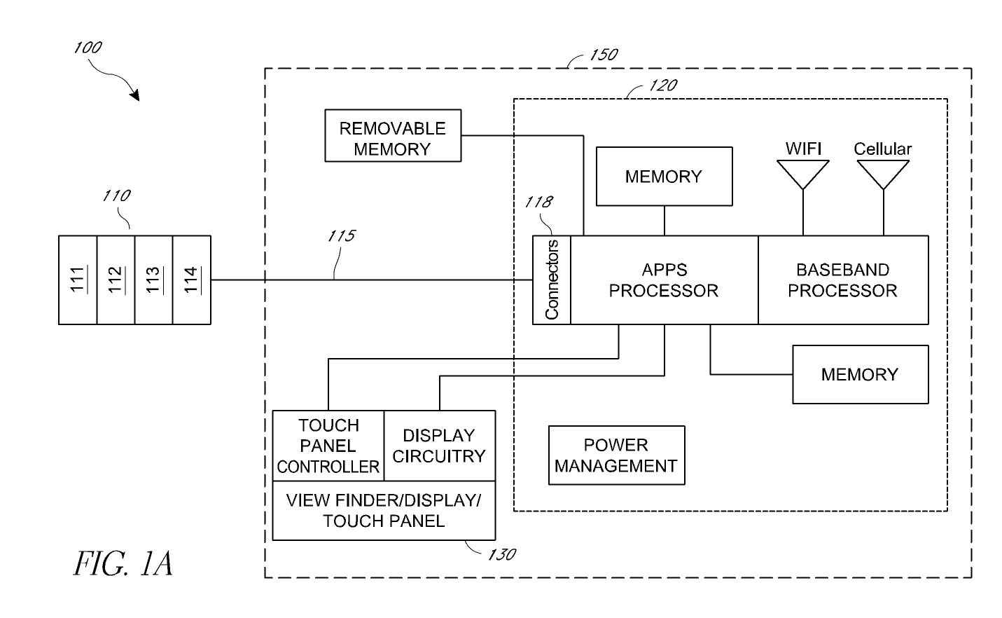

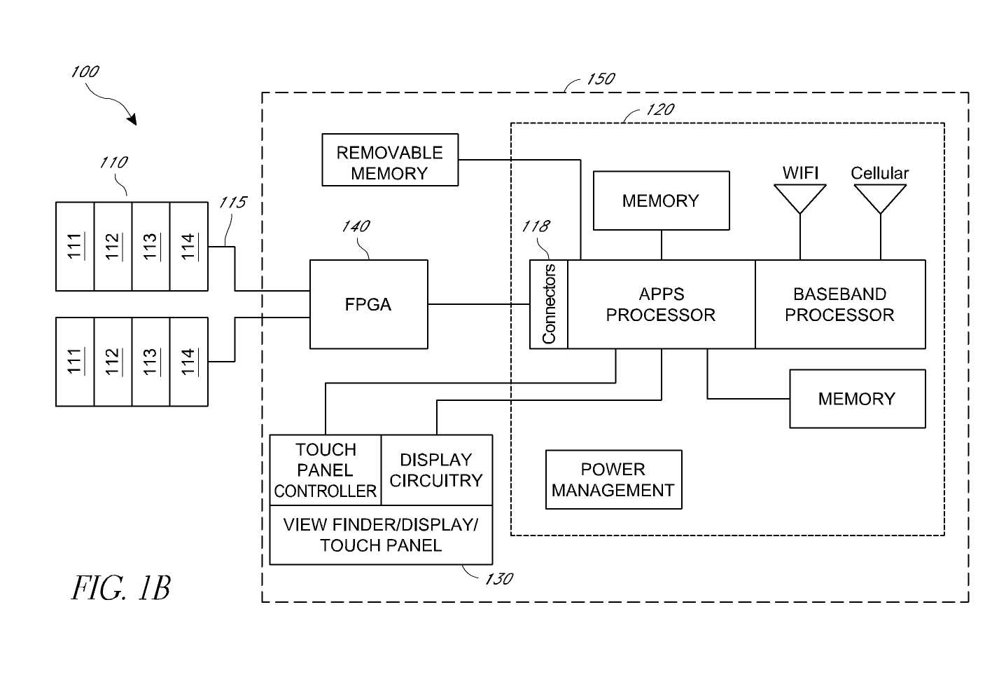

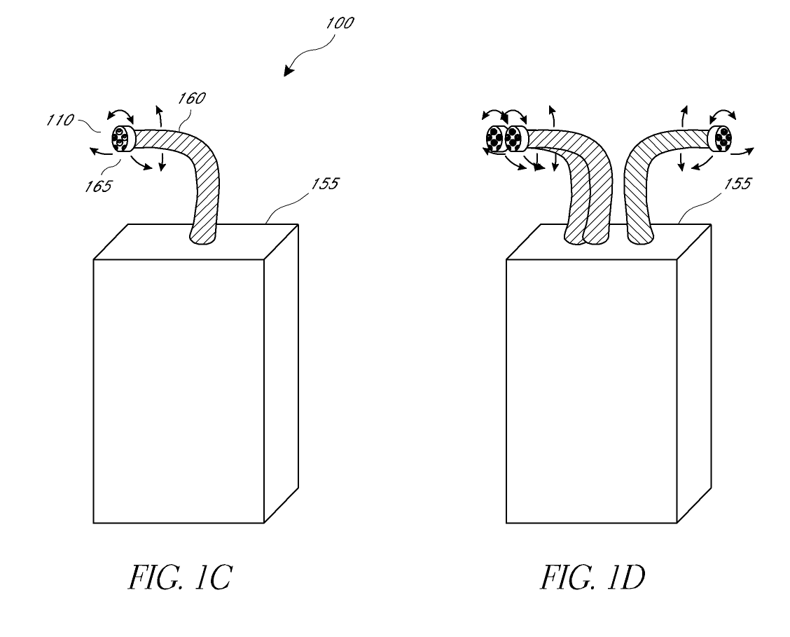

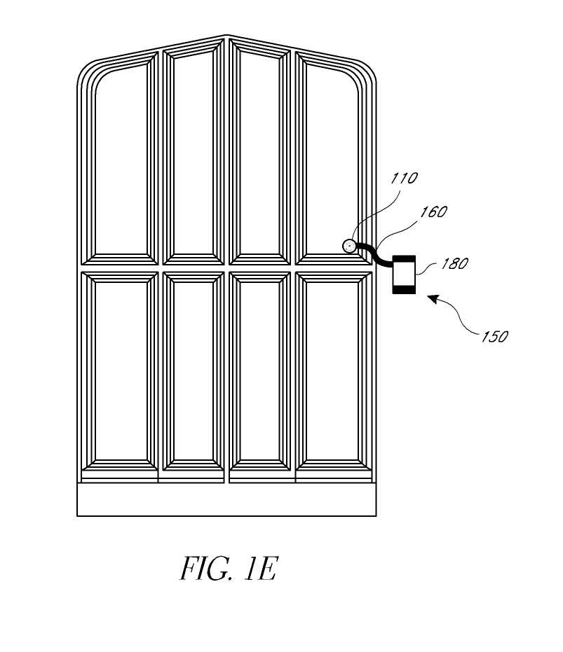

As illustrated in FIG. 1A, in one embodiment, a device for visual monitoring (VM device) 100 includes one or more camera heads 110 and a camera body 150. The camera body includes a wireless chipset 120 (which could be, for example, a mobile chipset), and an optional display/input module 130. The camera heads and the wireless chipset are communicatively coupled via connections 115. Each camera head (or camera) 110 includes one or more apertures 111, one or more lenses 112, one or more sensors 113, and connectors 114 coupled to connections 115. The one or more apertures 111 and lenses 112 can be in a different order than shown and can be interspersed to create a multi-aperture camera. The chipset 120 can be any chipset designed for use in a communication device such as a smartphone, personal digital assistant (PDA) device, or any other communication device, and includes a group of integrated circuits, or chips, that are designed to work together in a communication device. In one embodiment, the chipset includes one or more processors, such as an apps processor and/or a baseband processor. The apps processor is coupled to the camera 110 via connectors 118, which are coupled to connections 115. The chipset 120 can further include one or more memory components for storing data and program codes. The apps processor executes application programs stored in one or more of the memory components to process sounds, images, and/or videos captured by the camera 110. The memory components can include one or more memory chips including dynamic random access memory (DRAM) and/or flash memory. The VM device 100 can further include one or more removable memory components, which can come in the form of one or more memory cards, such as SD cards, and can be used to store sounds, images, and/or videos captured by a camera 110 and/or processed by the apps processor. The baseband processor processes communication functions (not shown) in order to transmit images processed by the apps processor via local area wireless network (for example, Wi-Fi) communication and/or wide area network communication (for example, cellular). The chipset 120 can further include a power management module coupled to a battery (not shown) and/or an external power source (not shown). The power management module can manage and supply power to the electronic components in the VM device 100. The VM device 100 also can include one or more batteries and/or a power adaptor that converts AC power to DC power for use by the VM device.

The optional display/input module 130 can include a display (for example, a LCD display) that displays preview images, still pictures and/or videos captured by a camera 110 and/or processed by the apps processor, a touch panel controller (if the display is also used as an input device), and display circuitry.

In some embodiments, the camera body includes all or part of a communication device, such as a smartphone, personal digital assistant (PDA) device, or any other communication device.

In some embodiments, when the VM device 100 includes more than one camera, as shown in FIG. 1B, the VM device can also include a field-programmable gate array (FPGA) chip 140 coupled between the cameras and the mobile chipset. The FPGA chip can be used to multiplex signals between the cameras and the apps processor, and to perform certain image processing functions, as discussed below.

In some embodiments, the camera 110 and camera body 150 can be disposed in a single housing (not shown). In some embodiments, as shown in FIGS. 1C and 1D, the one or more cameras 110 are disposed at the heads of one or more support stalks 160, while the camera body 150 is disposed in a separate housing 155. In some embodiments, the housing is weatherproof so the VM device 100 can be mounted outdoors. The stalks are flexible so that the heads can be positioned to face different directions giving a wider field of view. Furthermore, the cameras can be disposed in one or more protective housing units 165 with a transparent face and/or a sun visor (not shown), and mechanisms are provided to allow the camera(s) to swivel so that the images captured by the camera can be kept correctly oriented no matter which direction the camera is facing. This swivel motion can be limited (for example, plus or minus 180 degrees) with pins as stops so that the cable inside of the stalk does not become too twisted. In addition, the sun visor will also be able to swivel so that the top part shields the lens from the sun. The stalks and the swivel head allow cameras 110 to be positioned to capture desired images without moving the body 155 of the VM device 100. In some embodiments, the wired connections 115 shown in FIGS. 1A and 1B include a flexible cable inside the stalks. The stalks can be sufficiently stiff to support their own weight and resist wind forces. The camera(s) on a stalk, the camera housing at the stalk head, the swivel mechanism (if provided), and the cables in the stalk comprise an eyestalk (hereinafter “eyestalk”).

In some embodiments, as shown in FIG. 1E, the eyestalk is an extension of a camera of a communication device, creating a smaller visible footprint in, for example, a store display. A conventional communication device has the camera fixed to its body. To create an eyestalk, a stalk 160 in the form of an extension cable is added between the camera and the rest of the communication device 180 so that the camera can be extended away from the communication device 180. The communication device 180 can be mounted away from view, while the camera can be extended via its stalk into the viewing area of the store display or at a small corner of a store window. This enables the communication device to access the view outside the venue while only the camera is visible. Since the size of the camera is much smaller than the rest of the communication device, the camera 110 takes a very small footprint in a store display.

In one embodiment, the camera 110 can include one or more fisheye lenses via an enclosed mount. The mount will serve the following purposes: (1) holding the fisheye lens in place; (2) mounting the entire camera 110 to a window with an adhesive tape; (3) protecting the communication device; and (4) angling the camera slightly downwards or in other directions to capture an adequate view of the store front. The fisheye lens will allow a wide field of view (FOV) so that as long as the mount is placed near the human eye-level, the VM device 100 can be used for counting or moving objects via a trip line method, as discussed below. This allows for the VM device 100 to be easily installed. A user can simply peel off the adhesive tape, mount the device near eye-level to the inside window of a store display, and plug it into a power supply. Optionally, the VM device 100 can be connected to a Wi-Fi hotspot, as discussed below. Otherwise, a cellular connection (for example, 3G) will be used by the VM device 100 as the default.

In other embodiments, a camera 110 is connected to the camera body via wireless connections (for example, Bluetooth connection, Wi-Fi, etc.). In some embodiments, the VM device 100 is a fixed install unit for installing on a stationary object.

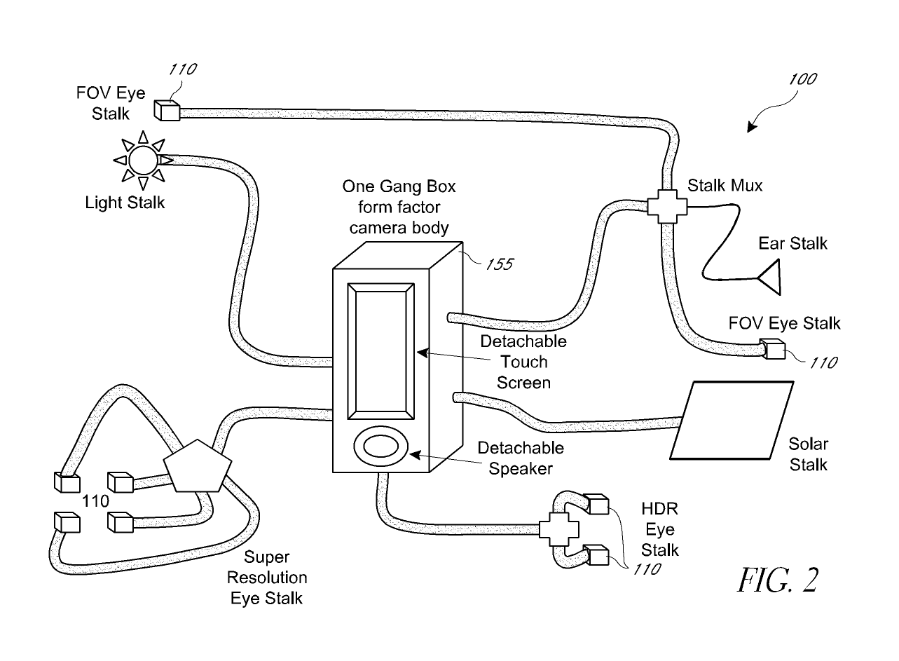

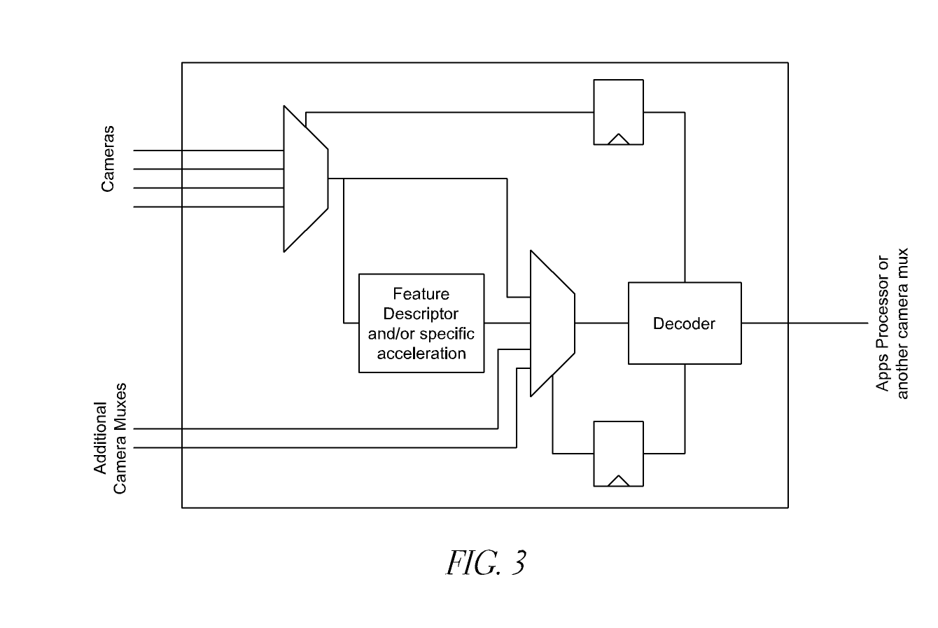

FIG. 2 illustrates a VM device 100 according to some embodiments. As shown in FIG. 2, the VM device 100 can include a plurality of eyestalks, a light stalk that provides illumination, and a solar stalk that provides power to the VM device 100. As shown in FIG. 2, multiple eyestalks can be connected to the camera body via a stalk multiplexer (mux). The stalk mux can include a FPGA and/or other type of circuit embodiment (for example, application-specific integrated circuit (ASIC)) (not shown that is coupled between the camera 110 and the apps processor. Alternatively, the stalk mux can be part of the camera body and can include a field programmable gate array (FPGA) or other type of circuit embodiment (for example, ASIC) (not shown) that is coupled between the camera 110 and the apps processor. Additionally, or alternatively, multiple cameras can be used to form a high dynamic range (HDR) eyestalk, lowlight eyestalks, clock phase-shifted high-speed camera eyestalks, and/or a super resolution eyestalk configuration. Coded apertures (not shown) and/or structured light (not shown) can also be used to enhance the pictures from the cameras. There can also be a field of view (FOV) eyestalk by having the cameras pointed in different directions. To handle the higher pixel rate caused by multiple eyestalks, compressive sensing/sampling is used to randomly sub-sample the cameras spatially and temporally. The random sub-sample can happen by having identical hash functions that generate quasi-random pixel addresses on both the camera and the device reconstructing the image. Another way is for the FPGA to randomly address the camera pixel array. Yet another way is for the FPGA to randomly skip pixels sent by the camera module. The compressively sampled picture can then be reconstructed or object recognition can be done either at the VM device or in the cloud. Another way of handling the higher pixel rate of multiple eyestalks with the processing power normally used for one eyestalk is to compress (such as JPEG compress) each of the pictures at the camera so that the data rate at the apps processor is considerably less. Alternatively, the FPGA can read the full pixel data from all the cameras and then compress the data down before it is sent to the apps processor. Another alternative is for the FPGA to calculate visual descriptors from each of the eyestalks and then send the visual descriptors to the apps processor. For FOV eyestalks, a smaller rectangular section of the eyestalks can be retrieved from the eyestalk and sent to the apps processor. Another alternative is for the FPGA or apps processor to extract and send patches of the picture containing only relevant information (for example, a license plate image patch versus an entire scene in a traffic-related application). Also, a detachable viewfinder/touchscreen can be tethered permanently or temporarily as another stalk or attached to the camera body. There also can be a cover for the viewfinder/touchscreen to protect it. In some embodiments, the camera body 150 with the viewfinder/touchscreen is enclosed in a housing 155, which can be weatherproof and can include a window for the viewfinder. The viewfinder can be activated when the camera is first powered on for installation, when its display is activated over a network, and/or when the camera is shaken and the camera accelerometer senses the motion.

FIG. 3 is a schematic diagram of the FPGA chip 140 coupled between multiple cameras and the apps processor. The FPGA chip 140 can be placed inside the housing 155 of the camera body 155 or close to the cameras 110 in a separate housing.

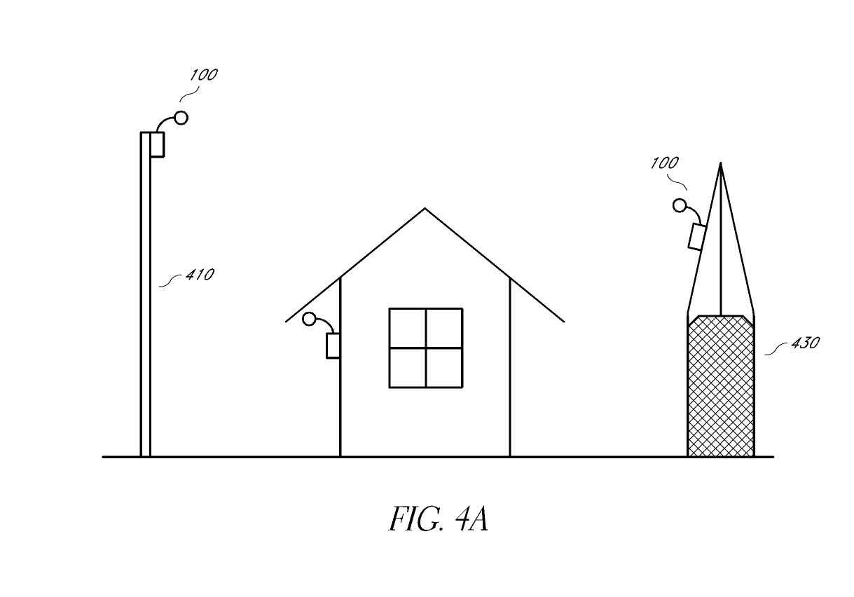

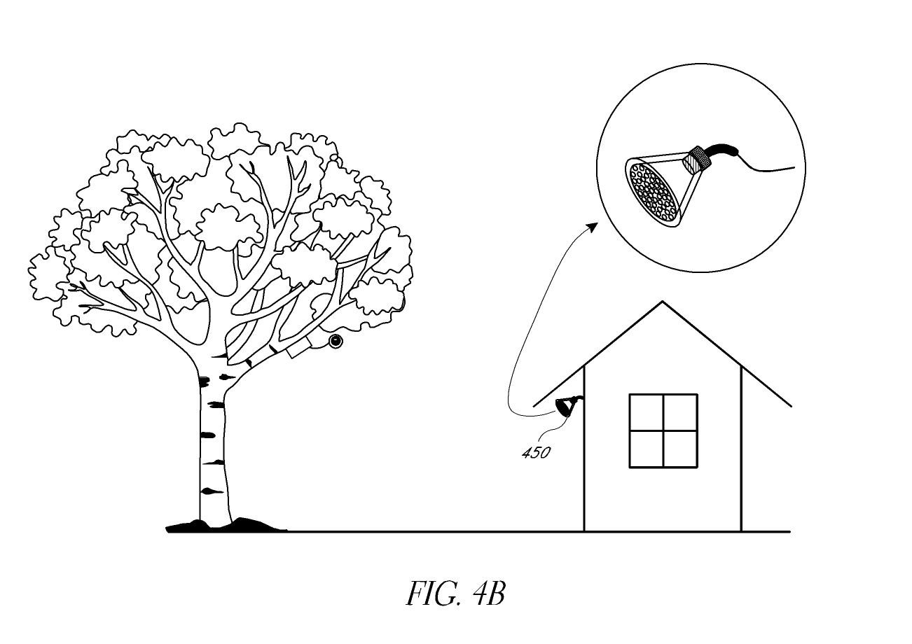

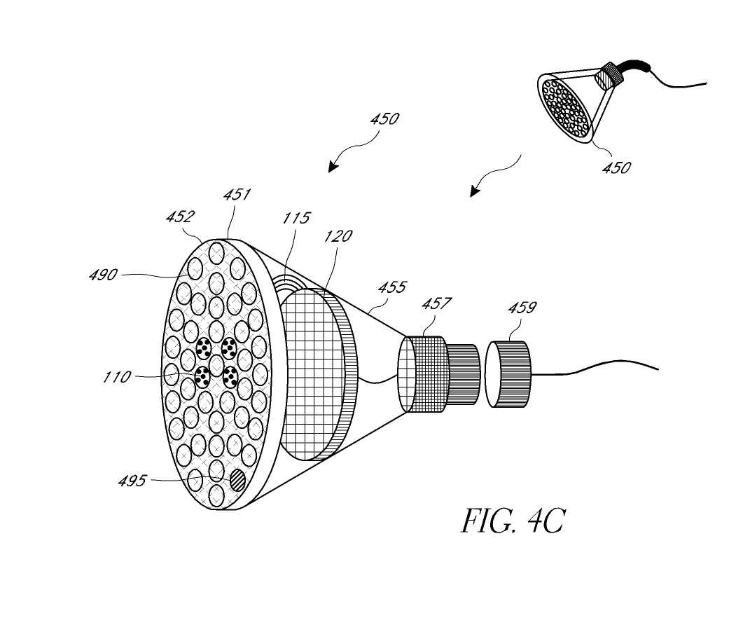

FIGS. 4A and 4B illustrate some applications of VM device 100. As shown in FIG. 4A, VM device 100 can be installed on a power pole 410 that is set up during the construction of a structure 420, or on/in the structure 420 itself. It also can be installed on or even integrated with a portable utility (for example, a port-a-potty with an integrated temporary power pole) 430. In one embodiment, the port-a-potty also serves as a support structure for power wires that provide temporary power for the construction of the structure. As shown in FIG. 4A, a VM device 100 includes one or more eyestalks that can be adjusted to position the camera(s) 110 to capture desired images or videos of the structure and/or some of its surroundings. As shown in FIG. 4B, VM device 100 can also be installed on a natural structure, such as a tree. Further, as shown in FIGS. 4B and 4C, VM device 100 can also be configured as a bulb replacement 450 and attached to a lamp or light fixture.

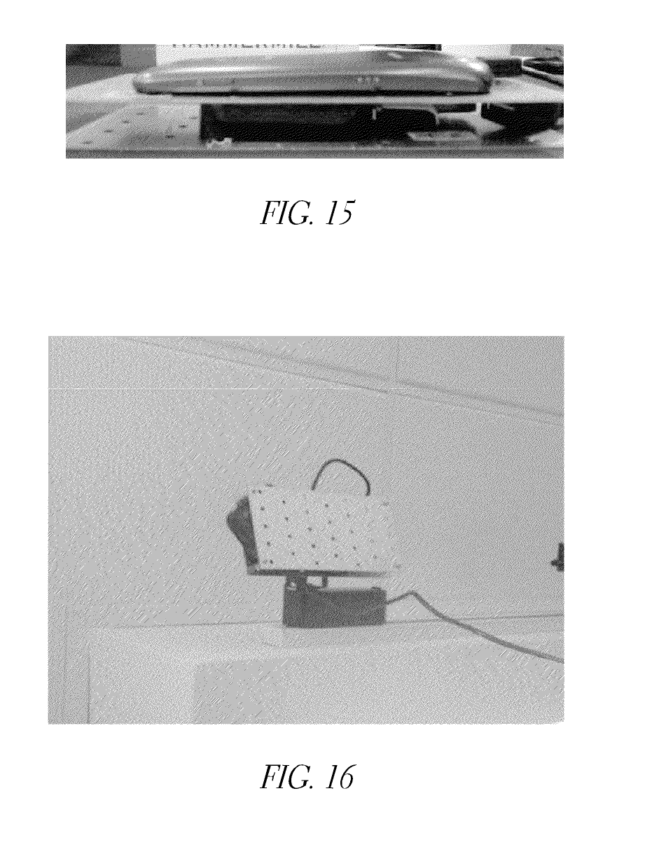

More specifically, some VM devices 100 can be configured to be attached to track lighting fixtures, as depicted in FIGS. 15 and 16. Advantageously, the track lighting fixtures can provide an existing installed power source in locations that are good for a VM device 100. Thus, a system of VM devices 100 can be installed at a venue with minimal setup and overhead positions for camera placement. In some embodiments, the VM device 100 can include a transformer module that converts a power source in the track lighting fixture to a form appropriate for the VM device (for example, by changing the voltage or changing between direct current (DC) and alternating current (AC)). Further, in some embodiments, the VM device 100 can include a wireless router (as best shown in FIG. 15A). Placing wireless routers at a track lighting fixture advantageously can be in an elevated position, thus providing a broader physical range of wireless connectivity. As also shown, the VM device 100 can include heat sinks such as large metal plates to dissipate heat generated by the VM device 100 and any included transformer modules.

When the VM device 100 is configured as a bulb replacement 450, the cameras 110 can be placed by themselves or among light emitting elements 451, such as LED light bulbs, behind a transparent face 452 of the bulb replacement. The mobile chipset 120 can be disposed inside a housing 455 of the bulb replacement. Further, a power adaptor 457 can be provided near the base of the bulb replacement. The power adaptor 457 can be configured to be physically and electrically connected to a base 459 of the lamp or light fixture, and also be configured to receive a light bulb or tube that is incandescent, fluorescent, halogen, LED, Airfield Lighting, or high intensity discharge (HID), either in a screw-in or plug-in manner. A timer or a motion sensor (such as an infrared motion sensor) 495 also can be provided to control switching the light emitting elements on or off. There also can be a mechanism (not shown) for some portion of the light bulb to rotate while the base of the bulb stays stationary, allowing the cameras to be properly oriented.

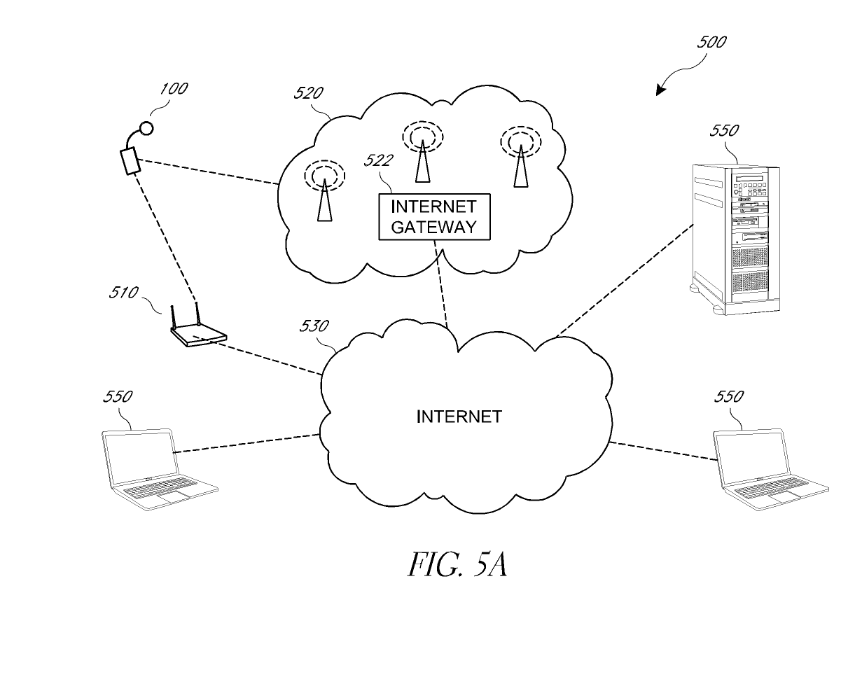

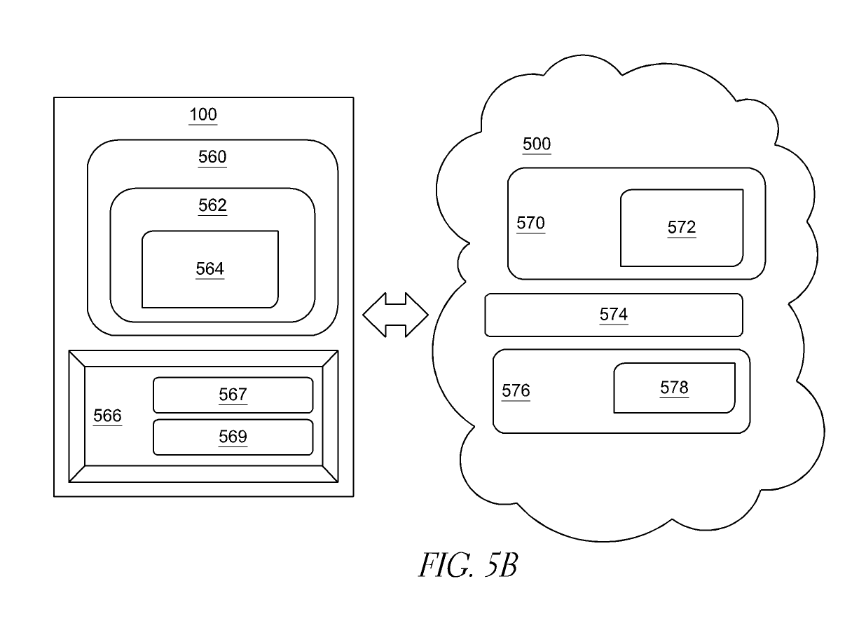

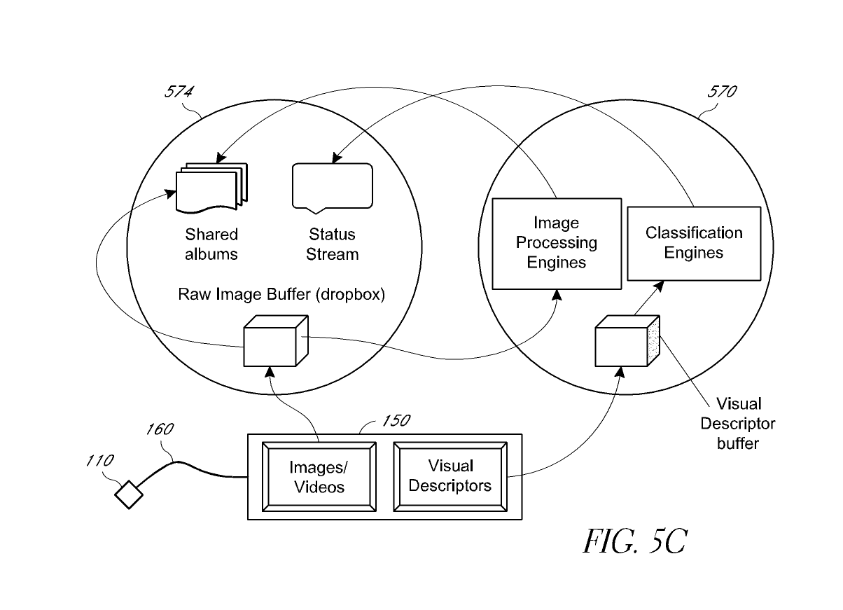

As shown in FIG. 5A, the VM device 100 includes Wi-Fi and/or cellular connections to allow it to be connected to a packet-based network 500 (hereinafter “the cloud”). In some embodiments, the packet-based network can include a Wi-Fi hotspot 510 (if one is available), part or all of a cellular network 520, the Internet 530, and computers and servers 550 coupled to the Internet. When a Wi-Fi hotspot is available, the VM device 100 can connect to the Internet via the Wi-Fi hotspot 510 using its built-in Wi-Fi connection. The VM device 100 can also communicate with the cellular network 520 using its built-in cellular connection and communicate with the Internet via an Internet Gateway 522 of the cellular network. The VM device 100 might also communicate with the cloud using wired Ethernet and optionally Power over Ethernet (PoE) (not shown). By connecting to the various modules described herein, a visual monitoring system including one or more of the VM devices 100 described herein and one or more information devices can be combined into a visual monitoring system where the individual devices communicate with a server (composed of one or more devices) at the same location, a separate location, or both.

FIG. 5B illustrates a software architecture associated with VM device 100 according to embodiments. As shown in FIG. 5B, the VM device 100 is installed with an operating system 560 (for example, any operating system configured to be used in mobile devices such as smartphones and PDAs, such as the Android operating system), and one or more camera application programs or “apps” (Camera App) 562 built upon the mobile operating system. The Camera App 562 can be a standalone program or a software platform serving as a foundation or base for various feature descriptors and triggering specific script programs. When multiple eyestalks are used, the VM device 100 further includes functions provided by a chip (for example, FPGA or ASIC) 566, such as image multiplexing functions 567 and certain image processing functions. Image processing functions can include such as feature/visual descriptor specific acceleration calculations (hardware acceleration) 569 and other functions. Hardware acceleration can also be used for offloading a motion detection feature from the Camera App 562.

In some embodiments, the mobile operating system is configured to boot up in response to the VM device 100 being connected to an external AC or DC power source (even though the VM device includes a battery). In some embodiments, the VM device 100 is configured to launch the Camera App 562 automatically in response to the operating system having completed its boot-up process. In addition, there can be a remote administration program so that the camera can be diagnosed and repaired remotely. This can be done by communicating to the administration program through the firewall via email, SMS, contacts, c2dm, or other protocols, and sending shell scripts or individual commands that can be executed by the camera at any layer of the operation system (such as at the Linux layer and/or the Android layer). Once the scripts or commands are executed, the log file is sent back via email or SMS. There can be some sort of authentication to prevent hacking of the VM 100 device via shell scripts.

In some embodiments, the VM device 100 communicates with servers 550 coupled to a packet-based network 500, which can include one or more software engines (such as an image processing and classification engine 570), a video stream storage and server engine 574, or an action engine 576. The image processing and classification engine 570 (built, for example, on Amazon's Elastic Computing Cloud or EC2e) can further include one or more classifier specific script processors 572. The image processing and classification engine 570 can include programs that provide recognition of features in the images captured by the VM device 100, and are uploaded to the packet-based network 500. The action engine 576 (such as the one on Amazon's EC2) can include one or more action-specific script processors 578. The video stream storage and server engine 574 also can be used to process and enhance images from the IP (Internet Protocol) camera using, (for example, multi-frame High Dynamic Range, multi-frame low-light enhancement, multi-frame super-resolution algorithms or techniques).

As shown in FIG. 5C, still images and/or videos uploaded from the VM device 100 are first stored in a raw image buffer associated with the video stream storage and server engine 574 (such as Google+) that hosts one or more social networks, and then transmitted to image processing engines 570 that process the images/videos and transmit the processed images/videos to shared albums associated with the video stream storage and server engine 574. Another possible configuration is for the VM device 100 to upload video directly to an image processing and classification engine 570 (which could, for example, be implemented on EC2), which then processes the data and sends it to a video stream storage server 574 (which could, for example, be implemented on Google+) (not shown).

Also, as shown in FIG. 5C, images and data for visual descriptor calculations are uploaded from the VM device 100 to a visual descriptor buffer 571 associated with the image processing and classification engines 570. Classification engines in the image processing and classification engines 570 perform visual descriptor classification on visual descriptors from the visual descriptor buffer, and transfer the resulting classification information to a status stream folder associated with the video stream storage and server engine.

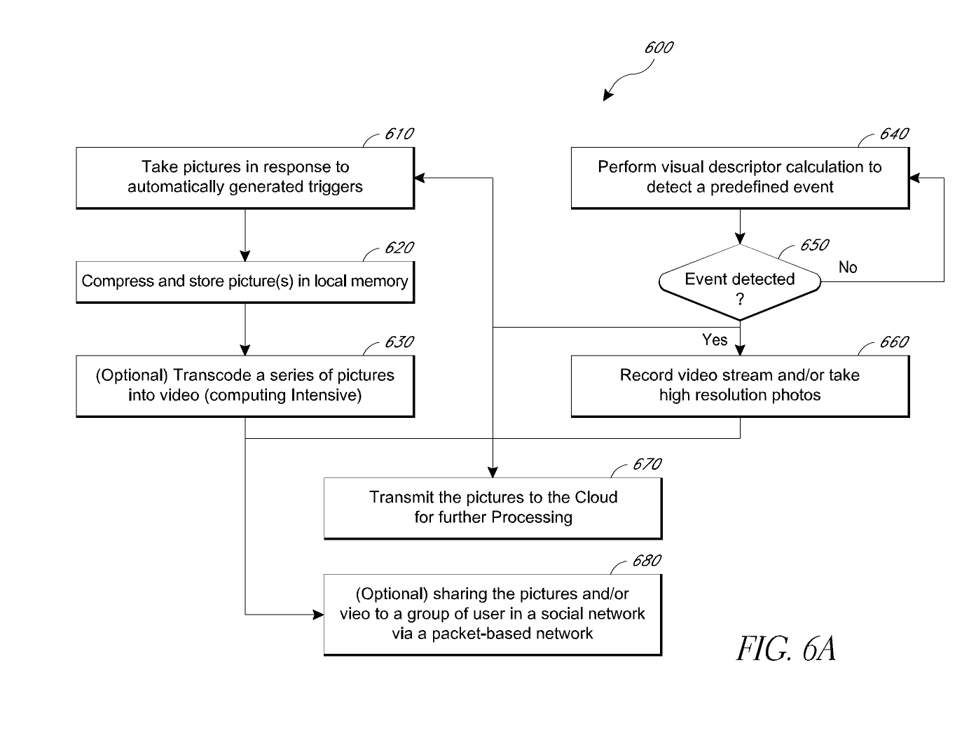

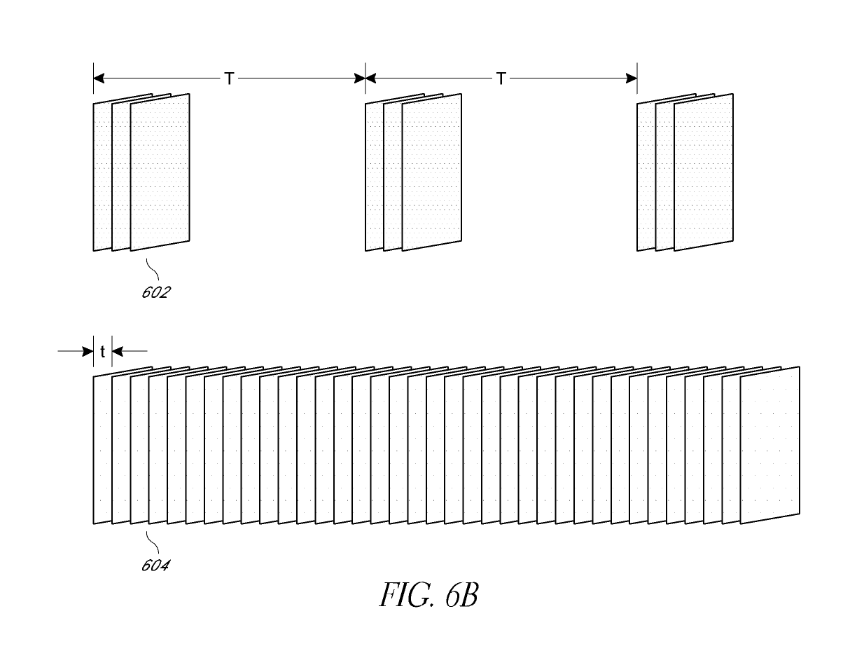

FIG. 6A illustrates a method 600 performed by VM device 100 when the Camera App 562, and/or one or more application programs built upon the Camera App 562, are executed by the apps processor to capture, process, and upload images/videos according to the embodiments. As shown in FIGS. 6A and 6B, VM device 100 is configured to take pictures 602 in response to automatically generated triggers 610. In one embodiment, the triggers come from an internal timer in the VM device 100, meaning that VM device takes one or a set of relatively high resolution pictures for each of a series of heart-beat time intervals T (for example, 5 seconds). In other embodiments, the triggers are generated by one or more application programs within or associated with the Camera App 562 as a result of analyzing preview images 604 acquired by the camera(s) 110. In either case, the triggers are automatically generated with no human handling of the VM device 100. In some embodiments, the pictures are compressed and stored in local memory 620, such as the flash memory or removable memory, and can be transcoded into video before being uploaded 630. The pictures are uploaded 670 to one or more servers 650 in the cloud 500 for further processing. In some embodiments, the pictures are selected so that a picture is uploaded 670 only when it is significantly different from a predetermined number of prior pictures.

VM device 100 is also configured to perform visual descriptor and classification calculations 640 using, for example, low resolution preview images 604 from the camera(s) that are refreshed at a much more frequent pace (for example, one image within each time interval t, where t<<T), as shown in FIG. 6B. In some embodiments, t can be between 1 and 100 microseconds, or approximately 50 microseconds. The relatively low-resolution images are analyzed by the VM device 100 to detect an interested event (for example, a person entering or exiting a premise, or a significant change between two or more images) 640. Upon detection of such event 650, the VM device 100 can be configured to record a video stream or perform computations for resolution enhancement of the acquired images 660.

In some embodiments, the VM device 100 is further configured to determine whether to upload stored high-resolution pictures based on certain criteria, which can include whether there is sufficient bandwidth available for the uploading (see below), whether a predetermined number of pictures have been captured and/or stored, or whether an interested event has been detected. If the VM device 100 determines that the criteria are met (for example, that bandwidth and power are available, that a predetermined number of pictures have been captured, that a predetermined time has passed since last uploading, and/or that an interested event has been recently detected), the VM device can upload the pictures or transcode/compress pictures taken over a series of time intervals (T) into a video using inter-frame compression and upload the video to the packet-based network. In some embodiments, the high-resolution pictures are compressed and uploaded without being stored in local memory and already are transcoded into video. In some embodiments, the camera is associated with a user account in a social network service. The camera uploads videos or pictures to the packet-based network with one or more identifiers that identify the user account in the social network service so that the pictures or videos are automatically shared among interested parties or stakeholders that are given permission to view the video through the social network service once they are uploaded 680.

In some embodiments, upon detection of an interested event, a trigger is generated to cause the VM device 100 to take one or a set of pictures and upload the picture(s) to the packet-based network. In some embodiments, the VM device 100 can alternatively or additionally switch to video mode and start to record video stream and/or to take high-resolution pictures at a much higher pace than the heartbeat rate. The video stream and/or high-resolution, high frequency pictures are uploaded to the packet-based network as quickly as bandwidth allows to allow quick viewing of the interested event by users. In some embodiments, the camera uploads the videos or pictures to the packet-based network together with one or more identifiers that identify the user account in the social network service so the pictures are automatically shared among a predefined group of social network service users.

The VM device 100 can be further configured to record diagnostic information and send the diagnostic information to the packet-based network on a periodic basis.

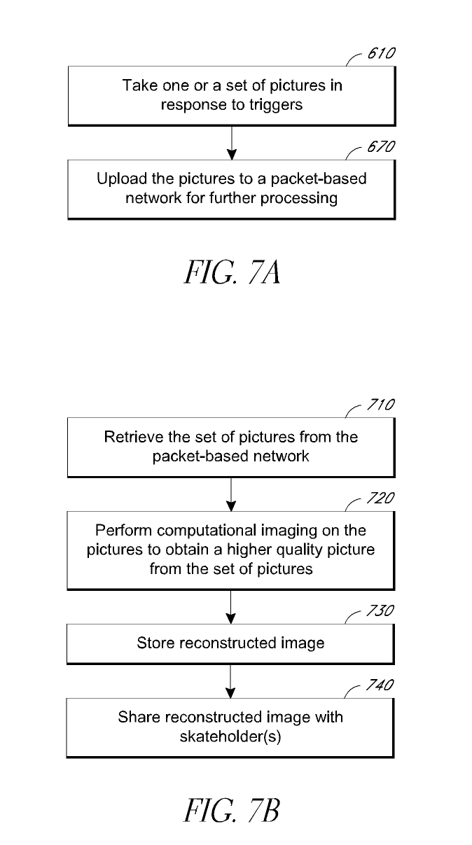

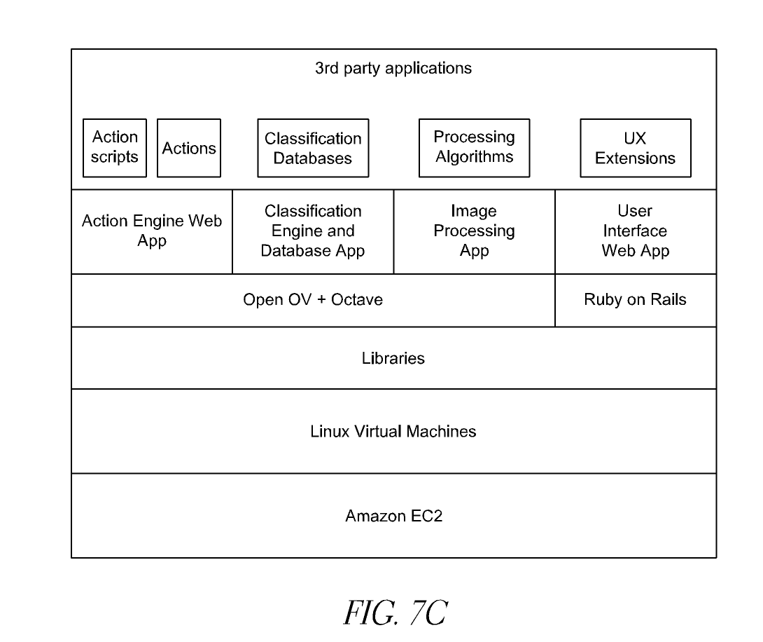

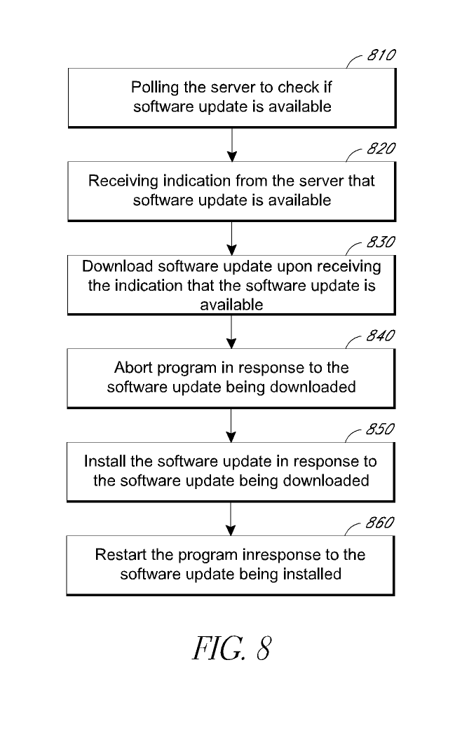

As shown in FIG. 7A, the VM device 100 takes one or a set of pictures in response to each trigger 610. The set of pictures are taken within very short time, which can be the shortest time interval in which the VM device 100 can take the set of pictures. The set of pictures can be taken by one or multiple cameras that are placed closely together, and are used for multi-frame/multi-eyestalks high dynamic range (HDR), low-light, or super resolution calculation performed at the VM device 100 or in the servers.

As shown in FIGS. 7A and 7B, when the HDR or super resolution calculation is performed in the cloud 500, the set of pictures taken by the VM device 100 in response to each trigger are uploaded 670 to the packet-based network for further processing. A server receiving the set of pictures 710 performs computational imaging on the pictures to obtain a higher quality picture from the set of pictures 720. The higher quality picture is stored 730 and/or shared 740 with group members of an online social network, the members being associated with a group of people or entities (for example, stakeholders of a project being monitors) who have permission to view the pictures.

The server also can perform computer vision computations to derive data or information from the pictures, and to share the data or information instead of pictures with one or more interested parties by email, or by posting to an online social network account.

FIG. 7C is a block diagram of a software stack at the server that performs the method shown in FIG. 7B and discussed in the above paragraphs. The server is based in the cloud (for example, Amazon EC2). One or more virtual machines are run in the cloud using an operating system (for example, Linux). These virtual machines can have many libraries on them, and in particular, libraries like Open CV and Rails. Open CV can be used for image processing and computer vision functions. Rails can be used to build interactive websites. Other programs (for example, Octave) can be used for image processing and computer vision functions. Ruby can be used on Rails to build websites. The action engine web app function can be built to conduct specific actions when triggered by an event. For example, if an application is using the VM device 100 to monitor a parking lot, if a parking spot being monitored becomes available, the action engine can notify the mobile device of a nearby driver who is looking for a parking spot. These actions can be added with action scripts (such as when a parking spot is available or to notify the driver), and actions (for example, send a message to the driver's smartphone) via APIs (application programming interface). One sensor platform can watch to see how many vehicles are entering a street segment and another sensor platform can watch to see how many cars are leaving a street segment. These sensor platforms can be placed on corners for greatest efficiency. All the entrances and exits of a street segment can be monitored by the sensor platforms to track how many vehicles are in a specific street segment. Also, signatures of the vehicles can be generated using visual descriptors to identify which vehicles are parked in a street segment or passed through a street segment. Using this method, the system can tell how many vehicles are parked in a street segment. This information can be used to increase parking enforcement efficiency because segments with vehicles parked over the allotted time are easily identifiable; alternatively, this information also can help drivers to identify areas where there is available parking. The classification engine and database app can try to match visual descriptors sent by the camera to the server to identify the object or situation in the database. Classification databases (for example, visual descriptors for different cars) can be added via APIs for specific applications. The image-processing app can process images (for example, create HDR or super-resolution images). Additional processing algorithms can be added via APIs. There also can be a web app providing a GUI for users to control the camera via the web browser. This GUI can be extended by third-parties via APIs.

In some embodiments, the VM device 100 is also loaded with a software update program to update the Camera App 562 and/or its associated application programs 564. FIG. 8 is a flowchart illustrating a process performed by the VM device 100 when the software update program is being executed by the apps processor. As shown in FIG. 8, the VM device 100 polls 810 a server storing software for the VM device 100 to check if a software update is available. When the VM device 100 receives 820 an indication from the server that software updates are available, it downloads 830 the software updates. In response to the software updates being downloaded, the VM device 100 could abort 840 the aforementioned visual monitoring program in order to install 850 the software update. The VM device 100 could restart the program 860 in response to the software update being installed. In one embodiment, all of the steps illustrated in FIG. 8 are performed automatically by the VM device 100 without user intervention.

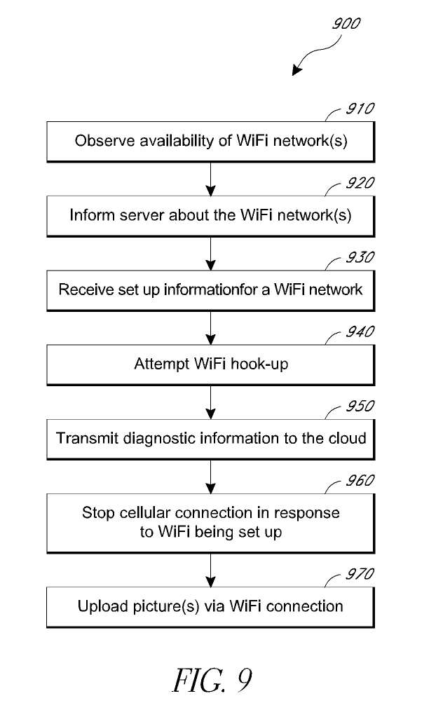

In some embodiments, the VM device 100 is also loaded with a Wi-Fi hookup assistance program to allow a remote user to connect the VM device to a nearby Wi-Fi hotspot via the packet-based network. FIG. 9 is a flowchart illustrating a process performed by the VM device 100 when the Wi-Fi hookup assistance program is being executed by the apps processor. As shown in FIG. 9, the VM device 100 would observe 910 availability of Wi-Fi networks, inform 920 a server about the availability of Wi-Fi networks, and receive set-up information for a Wi-Fi network. The VM device 100 would then attempt a Wi-Fi hook-up 940 using the set-up information it received, and transmit 950 any diagnostic information to the cloud 500 in order to inform the server whether the hook-up is successful. Upon successful hook-up to the Wi-Fi network, the VM device 100 would stop 960 using the cellular connection and start using the Wi-Fi connection to upload 970 pictures or data associated with the relevant pictures.

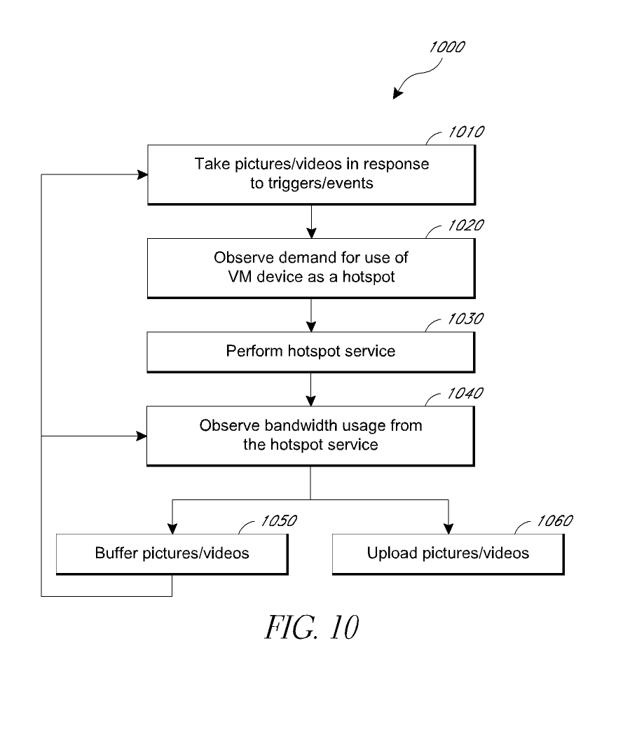

In some embodiments, the VM device 100 also is loaded with a hotspot service program allowing the VM device to be used as a Wi-Fi hotspot so that nearby computers can use the VM device as a hotspot to connect to the packet-based network. FIG. 10 is a flowchart illustrating a process performed by the VM device when the hotspot service program is being executed by the apps processor. As shown in FIG. 10, while the VM device 100 is taking 1010 pictures/videos in response to triggers/events, it would observe 1020 any demand for use of the VM device 100 as a Wi-Fi hotspot, and perform 1030 hotspot service. While it is performing the hotspot service, the VM device 100 would observe 1040 bandwidth usage from the hotspot service, and either buffer 1050 the pictures/videos when the hotspot usage is high, or upload 1060 the pictures/videos to the cloud 500 for further processing or sharing with a group of users of a social network when the hotspot usage is low.

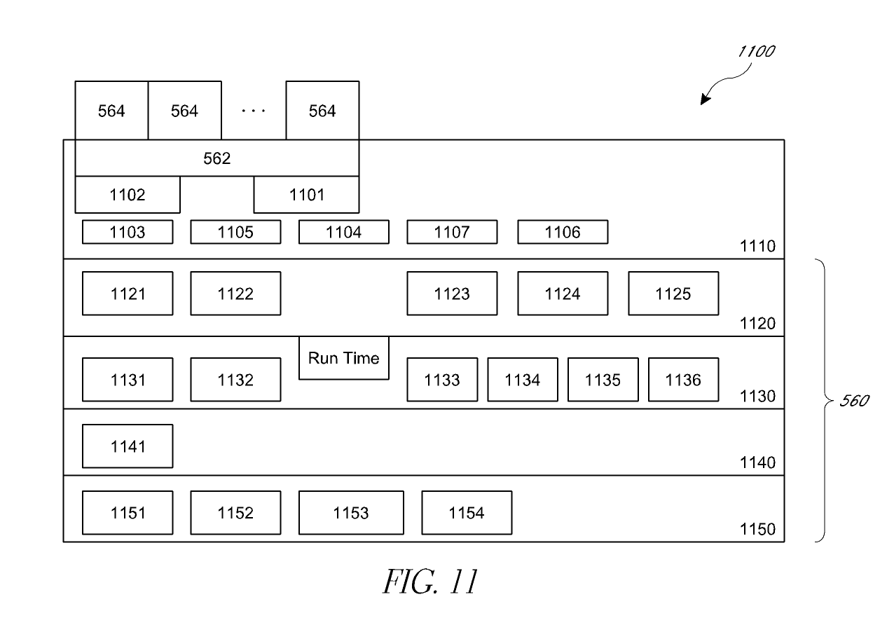

FIG. 11 is a block diagram illustrating a software stack 1100 associated with the VM device 100. As shown in FIG. 11, the Camera App 562 according to one embodiment can be implemented as part of an applications layer 1110 over a mobile operating system 560 (for example, the Android Operating System) with an application framework layer 1120 and a libraries layer 1130, which is built over a base operating system (for example, Linux) with a services layer 1140 and a kernel layer 1150. The applications layer 1102 can include other applications such as an administrator application 1101 for administrating the Camera App 562 and a watchdog application 1102 for monitoring the Camera App. The applications layer also can include applications such as an email system 1103 (such as Java mail) used by the Camera App 562 to send/receive email messages, a video encoding/decoding library 1104 (such as FFmpeg) that can be used by the Camera App to optionally transcode individual image files (such as JPG files), into, for example, an inter-frame H.264 video file that has 10-times higher compression rate, and/or computer vision library 1105 (such as Open CV), used by the Camera App to perform image processing and other computer vision tasks (for example, finding and calculating visual descriptors). The applications layer can include well-known applications such as a contact recorder 1106 for recording contacts information, instant messaging, and/or a short messaging service (SMS) 1107 utilized by the Camera App 562 to perform the functions of the VM devices 100 discussed herein.

The kernel layer of base operation system 1150 includes a camera driver 1151, a display driver 1152, a power management driver 1153, a Wi-Fi driver 1154, and other modules. The service layer 1140 includes service functions such as an initialization function 1141 that is used to boot-up operating systems and programs. In one embodiment, the initialization function 1141 is configured to boot-up the operating systems and the Camera App 562 in response to the VM device 100 being connected to an external power source instead of pausing at battery charging. It is also configured to set up permissions of file directories in one or more of the memories in the VM device 100.

In one embodiment, the camera driver 1151 is configured to control exposure of the camera(s) to: (1) build multi-frame HDR pictures; (2) focus to build focal stacks or sweep; (3) perform remote control picture capture functionality (such as scalado functionalities or speed tags); and/or (4) allow the FPGA to control multiple cameras and to perform hardware acceleration of triggers and visual descriptor calculations. In one embodiment, the display driver 1152 is configured to control the backlight to save power when the display/input module 130 is not used. In one embodiment, the power management driver is modified to control battery charging to work with a solar charging system provided by one or more solar stalks.

In one embodiment, the Wi-Fi driver 1154 is configured to control the setup of Wi-Fi via the packet-based network so that Wi-Fi connections of the VM device 100 can be set up using its cellular connections, as discussed above with reference to FIG. 9, such that a display module on the VM device might be omitted.

Still referring to FIG. 11, the mobile operating system includes a libraries layer 1130 and an application framework layer 1120. The libraries layer includes a plurality of runtime libraries. A graphic library 1131 (such as OpenGL|ES) is used by the Camera App 562 to accelerate the GPU for motion detection calculations, visual descriptor calculations such as those for finding interested feature points in captured images or videos, calculations related to image processing algorithms such as HDR fusion and low light boosting. A media framework 1132 is used by the Camera App 562 to compress pictures and videos for storage or uploading. A SSL 1133 (Secure Sockets Layer) is used by the Camera App 562 to authenticate via certain protocols (such as OAuth), to authenticate access to the social network and/or online storage accounts (such as Google+ or Picasa), and to set up HTTP transport. The SQLite 1135 is used by users or administrators of the VM device to remotely control the operation of the Camera App 562 and/or the VM device 100 by setting up and/or updating certain online information associated with an online user account (for example, email contacts). Such online information can be synced with the contacts information on the VM device 100 which is used by the Camera App 562 to set up parameters that determine how the Camera App runs and what functions it performs. This manner of controlling the VM device 100 allows the user to bypass the firewalls of the mobile operating system. Other such ways of controlling the VM device 100 through the firewall include, emails, chat programs, cloud services to device messaging, and SMS messages. The surface manager 1136 is used by the Camera App 562 to capture preview pictures from the camera(s), which can be used for motion detection and/or other visual descriptor calculations at a much higher frame rate than using pictures or videos to do the calculation. Other runtime libraries can also be used, such as libc 1134.

Still referring to FIG. 11, the application framework layer 1120 includes an activity manager 1121, content providers 1122, a view system 1123, a location manager, 1124 and a package manager 1125. The location manager 1124 can be used to track the VM device 100 if it is stolen, lost, or simply to add geo-location information to pictures/video. The package manager 1125 can be used to control updates and start/stop times for the Camera App 562.

Still referring to FIG. 11, in the applications layer, a watchdog program 1102 is provided to monitor the operation of the VM device 100. The watchdog 1102 can be configured to monitor the operating system and, in response to the operating system being booted up, launch the Camera App 562. The watchdog program notes when: (1) the VM device 100 has just been connected to external power; (2) the VM device 100 has just been disconnected from external power; (3) the VM device 100 has just booted up; (4) the Camera App 562 is forcibly stopped; (5) the Camera App is updated; (6) the Camera App is forcibly updated; (7) the Camera App has just started; and/or (8) other events that occur at the VM device 100. The watchdog can send notices to designated user(s) in the form of email messages when any or each of these events occur.

Also in the applications layer, an administrator program 1101 is provided to allow performance administrative functions such as shutting down the VM device 100, rebooting the VM device 100, stopping the Camera App 562, or restarting the Camera App, remotely via the packet-based network. In one embodiment, to bypass the firewalls, such administrative functions are performed by using the SMS application program or any of the other messaging programs provided in the applications layer or other layers of the software stack.

Still referring to FIG. 11, the software stack can further include various trigger generating and/or visual descriptor programs 564 built upon the Camera App 562. A trigger-generating program is configured to generate triggers in response to certain predefined criteria being met, and specific actions are then taken by the Camera App 562 in response to the triggers. A visual descriptor program is configured to analyze acquired images (for example, preview images) to detect certain prescribed events and notifies the Camera App 562 when such events occur and/or prescribe actions to be taken by the Camera App in response to the events. The software stack can also include other application programs 564 built upon the Camera App 562, such as the moving object counting program discussed below.

The Camera App 562 can include a plurality of modules, such as an interface module, a settings module, a camera service module, a transcode service module, a pre-upload data processing module, an upload service module, an optional action service module, an optional motion detection module, an optional trigger/action module, and an optional visual descriptor module.

For example, upon being launched by the watchdog program 1102 upon boot-up of the mobile operating system 560, the interface module performs initialization operations including setting up parameters for the Camera App 562 based on settings managed by the settings module. As discussed above, the settings can be stored in the contacts program and can be set-up/updated remotely via the packet-based network. Once the initialization operations are completed, the camera service module starts to take pictures in response to certain predefined triggers; these triggers can be generated by the trigger/action module in response to events generated from the visual descriptor module, or certain predefined triggers, such as the beginning or ending of a series of time intervals according an internal timer. The motion sensor module can start to detect motions using the preview pictures. Upon detection of certain motions, the interface module would prompt the camera service module to record videos or take high-definition pictures or sets of pictures for resolution enhancement or HDR calculation, or the action service module to take certain prescribed actions. It can also prompt the upload module to upload pictures of videos associated with the motion event.

Without any motion or other visual descriptor events, the interface module can decide whether certain criteria are met for pictures or videos to be uploaded (as described above) and can prompt the upload service module to upload the pictures or videos, or the transcode service module to transcode a series of images into one or more videos and upload the videos. Before uploading, the pre-upload data processing module can process the image data to extract selected data of interest, and can group the data of interest into a combined image, such as the trip line images discussed below with respect to an object counting method. The pre-upload data processing module can also compress and/or transcode the images before uploading.

The interface module is also configured to respond to one or more trigger-generating programs and/or visual descriptor programs built upon the Camera App 562, and prompt other modules to act accordingly, as discussed above. The selection of which triggering events to respond to can be determined using the settings of the parameters associated with the Camera App 562, as discussed above.

One application of the VM device 100 is using it to visually record information from gauges or meters remotely. The camera can take periodic pictures of the gauge or gauges, convert the gauge picture using computer vision into digital information, and then send the information to a desired recipient (for example, a designated server). The server can then use the information per the designated action scripts (for example, send an email out when the gauge reads empty).

In another application of the VM device 100, the device can be used to visually monitor a construction project or any visually recognizable development that takes a relatively long period of time to complete. The camera can take periodic pictures of the developed object and send images of the object to a desired recipient (for example, a designated server). The server can then compile the pictures into a time-lapsed video, allowing interested parties to view the development of the project quickly and/or remotely.

In another application of the VM device 100, the device can be used in connection with a trip line method to count moving objects. In one embodiment, as shown in FIG. 1E and FIG. 5, the VM device 100 comprises a communication device 180 (such as a modified Android smartphone) with a camera 110 on a tether, and a server 550 in the cloud 500 is connected to the communication device 180 via the Internet 530. The camera 110 can be mounted on the inside window of a storefront with the communication device mounted on the wall by the window. This makes for a very small footprint since only the camera 110 is visible through the window from outside the storefront.

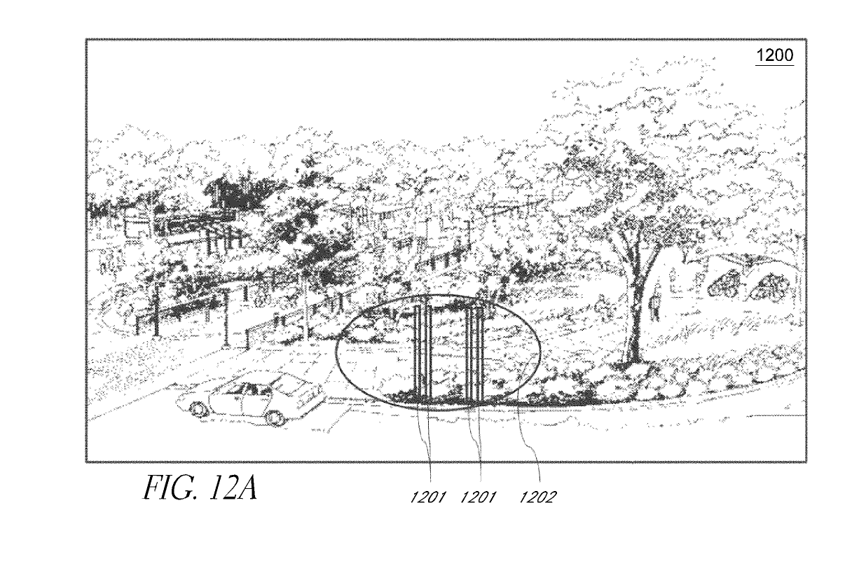

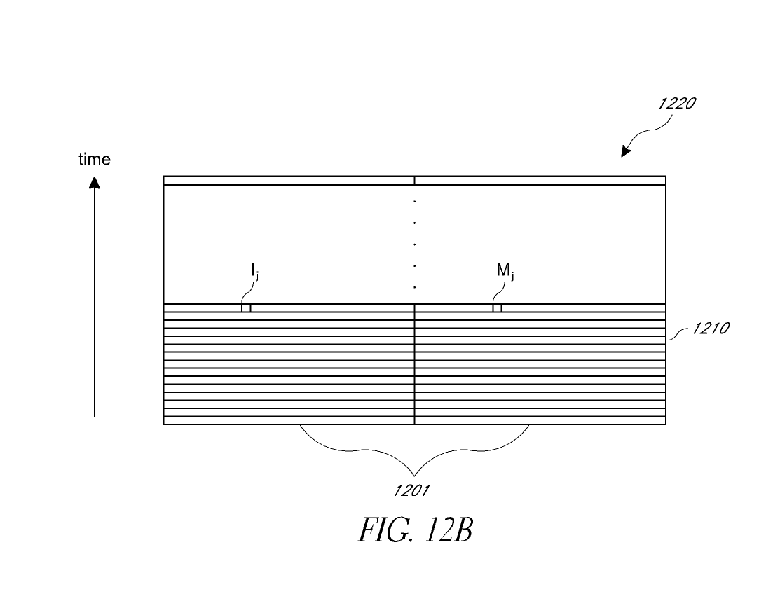

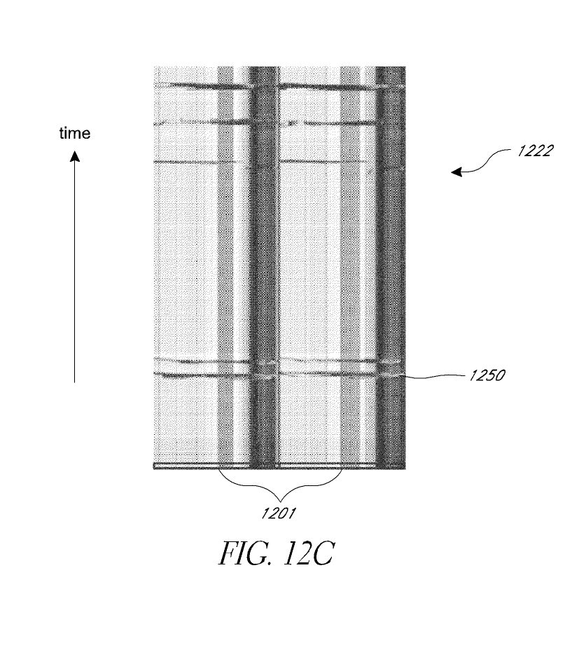

As shown in FIG. 12A, in a camera's view 1200, one or more line segments 1201 for each region of interest 1202 can be defined. Each of these line segments 1201 is called a trip line. Trip lines can be set up in pairs. For example, FIG. 12A shows two pairs of trip lines. On each frame callback, as shown in FIG. 12B, the VM device 100 stacks all the pixels that lie on each of a set of one or more trip lines, and joins the pixel line segments into a single pixel row/line 1210. For example, in FIG. 12B, pixels from a pair of trip lines at each frame callback are placed in a horizontal line. Once the VM device 100 has accumulated a set number of lines 1210 (usually 1024 lines), these lines now form a two-dimensional array 1220 of YUV pixel values. This two-dimensional array is equivalent to an image (trip line image) 1220. This image 1220 can be saved to the SD card of the communication device and then compressed and sent to the server by the upload module of the Camera App 562. The outcome image has the size of W×1024, where W is the total number of pixels of all the trip lines in the image. The height of the image can represent time (i.e., 1024 lines is approximately 1 minute). A sample trip line 1222 image is shown in FIG. 12C. The image 1222 comprises pixels of two trip lines of a sidewalk region in a store front, showing 5 pedestrians crossing the trip lines at different times. Each region usually has at least 2 trip lines to calculate direction and speed of detected objects. This is done by measuring how long it takes for the pedestrian to walk from one trip line to the next. The distance between trip lines can be measured beforehand.

The server 550 processes each trip line image independently. It detects foregrounds and returns the starting position and the width of each foreground region. Because the VM device 100 automatically adjusts its contrast and focus, intermittent lighting changes occur in the trip line image. To deal with this problem in foreground detection, a MTM (Matching by Tone Mapping) algorithm is first used to detect the foreground region. In one embodiment, the MTM algorithm comprises the following steps:

Breaking trip line segment;

K-Means background search;

MTM background subtraction;

Thresh-holding and event detection; and

Classifying a pedestrian group.

Because each trip line image can include images associated with multiple trip lines, the trip line image 1220 is divided into corresponding trip lines 1210 and MTM background subtraction is performed independently.

In the K-Means background search, because a majority of the trip lines are background, and because background trip lines are very similar to each other, k-means clustering is used to find the background. In one embodiment, grey-scale Euclidean distance as a k-means distance function is used:

D=Σⱼ₌₀^{N}(Ij−Mj)²

where I and M are two triplines with N pixels. Ij and Mj are pixels at j position, as shown in FIG. 12B. More than two triplines can also be used.

The K-means++ algorithm can be used to initialize k-means iteration. For example, K is chosen to be 5. In one embodiment, a trip line is first chosen from random as the first cluster centroid. Distances between other trip lines and the chosen trip line are then calculated. The distances are used as weights to choose the rest of cluster centroids. The bigger the weight, the more likely it is to be chosen.

After initialization, k-means is run for a number of iterations, which should not exceed 50 iterations. A criterion, such as a cluster assignment that does not change for more than 3 iterations, can be set to end the iteration.

In one embodiment, each cluster is assigned a score. The score is the sum of the inverse distance of all the trip lines in the cluster. The cluster with the largest score is assumed to be the background cluster (i.e., the largest and tightest cluster is considered to be the background). Distances between other cluster centroids to the background cluster centroid are then calculated. If any distance is smaller than 2 standard deviations of the background cluster, it is merged into the background. K-means can then be performed again with the merged clusters.

One example of a MTM algorithm is a pattern matching algorithm proposed by Yacov Hel-Or et. al. It takes two pixel vectors and returns a distance that ranges from 0 to 1, where 0 means the two pixel vectors are not similar and 1 means the two pixel vectors are very similar.

For each trip line, the closest background trip line (in time) from the background cluster is found. The distance between the two is then determined, for example with a MTM. In one embodiment, an adaptive threshold MTM distance is used. For example, if an image is dark, meaning the signal to noise ratio is high, then the threshold is high. If an image is indoors and has sufficient lighting conditions, then the threshold is low. The MTM distance between neighboring background cluster trip lines can be calculated (i.e., the MTM distance between two trip lines that are in the background cluster obtained from k-means and are closest to each other in time). The maximum of intra-background MTM distance is used as a threshold. The threshold can be clipped, for example, between 0.2 and 0.85.

If MTM distance of a trip line to an object is higher than the threshold, it is considered to belong to an object, and it is labeled with a value to indicate that it belongs to an object (for example, with a “1”). A closing operator is then applied to close any holes. A group of connected 1s is called an event of the corresponding trip line.

In one embodiment, the trip lines come in pairs, as shown in FIGS. 12a-12C. The trip line pair is placed sufficiently close so that if an object crosses one trip line, it should cross the other trip line as well. Pairing is a good way to eliminate false positives. Once all the events in the trip lines are found, they are paired up, and orphans are discarded. In a simple pairing scheme, if one object cannot find a corresponding or overlapping object on the other trip line, it is an orphan.

The aforementioned trip line method for object counting can be used to count vehicles as well as pedestrians. When counting cars, the trip lines are defined in a street. Since cars move much faster, the regions corresponding to cars in the tripline images are smaller. In one embodiment, at 15-18 fps the tripline method achieves a pedestrian count accuracy of 85% outdoors and 90% indoors, and a car count accuracy of 85%.

In one embodiment, the trip line method can also be used to measure dwell time, i.e. the duration of time in which a person dwells in front of a venue such as a storefront. Several successive trip lines can be set up so that the images of a storefront and the pedestrian velocity as they walk in front of the storefront, can be measured. The velocity measurements can then be used to get the dwell time of each pedestrian. The dwell time can be used as a measure of the engagement of a window display.

Alternatively, or additionally, the VM device 100 can be used to sniff local Wi-Fi traffic and associated MAC addresses of local Wi-Fi devices. In one embodiment, the VM device 100 can be used to sniff local Wi-Fi traffic and/or associated MAC addresses of local Wi-Fi devices. Since the MAC addresses are associated with people who are near the VM device 100, the MAC addresses can be used for counting people because the number of unique MAC addresses at a given time can be an estimate of the number of people with smartphones.

Since MAC addresses are unique to a device and thus unique to a person carrying the device, the MAC addresses also can be used to track return visitors. To preserve the privacy of smartphone carriers, the MAC addresses are never stored on any server. What can be stored instead is a one-way hash of the MAC address. From the hashed address, one cannot recover the original MAC address. When a MAC address is observed again, it can be matched with a previously recorded hash.

Wi-Fi sniffing allows uniquely identifying a visitor by his/her MAC address (or hash of the MAC address). The camera can also record a photo of the visitor. Then, either by automatic or manual means, the photo can be labeled for identifying characteristics (such as gender, approximate age, or ethnicity). The MAC address can be tagged with the same labels. This labeling can be done just once for new MAC addresses so that this information can be gathered in a more scalable fashion and, over a period of time, a large percentage of the MAC addresses will have demographics information attached. This enables the MAC addresses to be used for counting and tracking by demographics. Another application is to associate the MAC address of a particular visitor with that visitor's identifying information, such as in association with a loyalty card system. When the visitor nears and enters a venue, the venue staff knows that this visitor is physically present and can better service this person by identifying his or her preferences, determining the visitor's significance to the venue, and determining whether the person is a new or repeat visitor.

In addition to the Wi-Fi counting and tracking described above, audio signals also can be incorporated. For example, if the microphone detects the cash register, the associated MAC address (visitor) can be labeled with a purchase event. If the microphone detects a door chime, the associated MAC address (visitor) can be labeled as entering the venue. Similarly, if the VM device 100 is associated in a system with a cash register or other point-of-sale device, information about the specific purchase can be associated with the visitor.

For a VM device 100 mounted inside a store display, the number of people entering the venue can be counted by counting the number of times a door chime rings. The communication device can use its microphone to listen for the door chime and report the door chime count to the server.

In one embodiment, a VM device 100 mounted inside a store display can listen to the noise level inside the venue to estimate the number of people present. The communication device can average the noise level it senses inside the venue continuously, such as each second. If the average noise level increases at a later time, then the number of people inside the venue most likely increased, and similarly if the noise level decreases then the number of people most likely decreased.

For a sizable crowd such as a restaurant environment, the audio generated by the crowd is a very good indicator of how many people are present in the environment. If one were to plot the recording from a VM device 100 disposed in a restaurant, the plot would show that the volume increases as the venue opens, and continues to increase when the restaurant becomes increasingly busy.

In one embodiment, background noise is filtered. Background noise can be any audio signal that is not generated by humans (for example, background music in a restaurant). The audio signal is first transformed to the frequency domain, and then a band-limiting filter can be applied between 300 Hz and 3400 Hz. The filtered signal is then transformed back to the time domain and the audio volume intensity is calculated.

Other sensing modalities that can be utilized include the following: barometric, accelerometer, magnetometer, compass, GPS, and gyroscope. These sensors, along with the sensors mentioned above, can be fused together to increase the overall accuracy of the system. Sensing data from multiple sensor platforms in different locations also can be merged together to increase the overall accuracy of the system. In addition, once the data is in the cloud, the sensing data can be merged together with other third-party data (such as weather, point-of-sales, reservations, events, or transit schedules) to generate a prediction of future data and analytics. For example, pedestrian traffic is closely related to the weather. By using statistical analysis, the amount of pedestrian traffic can be predicted for a given location.

A more sophisticated application of prediction using data and analytics could be site selection for retailers. The basic process is to benchmark existing venues to understand what the traffic patterns look like outside an existing venue, and then to correlate the point-of-sales for that venue with the outside traffic. From this data, a traffic-based revenue model can be generated. Using this model, prospective sites are measured for traffic and the likely revenue for the site can be estimated. Sensor platforms deployed for prospective venues often do not have access to power or Wi-Fi. In these cases, the communication devices will be placed in exterior units so that they can be strapped to poles, trees, or temporarily attached to the sides of buildings. An extra battery will be attached to the communication device instead of the enclosure so that the sensor platform can run entirely on battery. Additionally, compressive sensing techniques will be used to extend battery life, and cellular radio will be used in a non-continuous manner to extend battery life of the platform.

Another use case is to measure the conversion rate of pedestrians walking by a storefront or entering a venue. This can be done with two sensor platforms (such as VM devices 100); one watches the street and another watches the door. Alternatively, a two-eyestalk sensor platform can be used to have one eyestalk camera watching the street and another watching the door. The two-camera solution can allow both cameras to share the radio and computational functions. By recording when the external storefront changes (such as new posters in the windows, new banners), a comprehensive database of conversion rates can be compiled that allows predictions of which type of marketing tool will best improve conversion rates.

Another embodiment is to use the cameras on the sensor platform in an area where many sensor platforms are deployed. Instead of having out-of-date photos taken a few months before, real-time photos can be merged with existing photos (such as on Google Streetview or another internet photo source) to provide a more up-to-date visual representation of how a particular street appears at that moment.

In further embodiments, the VM device 100 (or, similarly, systems of VM devices) can be configured to detect groups of visitors. For example, on some occasions, a family will arrive at a venue as a group. For some purposes, it might not be useful to consider every member of the group as a separate person (for example, in a retail setting where purchases from more than one member of the group are unlikely). A common example of this is when at least one parent comes to a grocery store with one or more children as a family unit. In this situation, usually only one purchase is made by one member of the group. Further, the same purchase would likely be made if only one member of the group (for example, a parent) came alone. Thus, it may be advantageous to identify the group as a single visitor group unit.

Single visitor group units can be identified in a number of ways. For example, in some embodiments image and video data from the cameras can be analyzed to identify people who move in groups. Multiple people who remain in close physical proximity or who make physical contact with each other can be identified as being in a single group (for example, using the average distance between members of the group or a number of detected touches between members of the group). Similarly, in embodiments where cameras view a parking lot or entrance, people who arrive in the same car or otherwise arrive at a venue at the same time can be identified as being in a single group.

In further embodiments, groups can be identified using wireless connectivity information. For example, people living in the same house, working at the same venue, or otherwise frequenting the same locations can carry smartphones or other Wi-Fi enabled devices that are configured to connect to particular wireless networks. These devices, while in the venue, might beacon for the Service Set Identification (SSID) of the same wireless network or router. This information can also be used to identify a single group.

In some embodiments, the various methods for identifying groups can be combined. For example, in some embodiments each type of data can be combined and processed to produce a probability or score indicative of the likelihood that the visitors are part of a single group or visitor unit. If this probability or score exceeds a certain threshold, the system can identify them accordingly.

Further, in some embodiments the system can identify a type of group or visitor unit. For example, in some embodiments, children can be identified by their size using visual data. Thus, a family visitor unit can be identified when one or more adults and one or more children are identified as a group. Further, in some embodiments the age of the children can be estimated according to their size. Even further, in some embodiments, a parent in a family visitor unit can be identified by a larger size. Further, in some embodiments, a group leader can be identified according to which member of the group ultimately makes a purchase. In other embodiments, groups or visitor units that consistently visit together can be identified as a family visitor unit. In other embodiments, people that visit together inconsistently can be identified as friend visitor units. As discussed herein, the VM device 100, and systems associated with multiple said devices, can treat members of certain groups differently (for example, by providing targeted content items such as advertisements directed toward group units and group members).

In some embodiments, the number of total visitors to a venue can be tracked. In further embodiments, the number of individual visitor units can be tracked. Even further, in some embodiments, the number, size, and type of visitor units can be tracked.

Further, it will be understood that in some embodiments, substantially all visitors to a venue can be tracked automatically, as described herein. In further embodiments, information regarding these visitors can be tracked and analyzed in real-time, as described herein. In other embodiments, some or all of the data analysis may be done at a later time, particularly when no immediate action is desired from the systems, as described herein. In further embodiments, 10 or more, 50 or more, or 100 or more visitors can be tracked simultaneously, in real-time.

In addition to identifying groups or visitor units, the VM device 100 and associated systems can be configured to identify individual people. Generally, as discussed above, individuals can be identified using visual data such as a picture or video. Further, individuals can be identified by a Wi-Fi enabled device (for example, by the MAC address of the device). Even further, in some embodiments, individuals can be identified by audio, using their voice. Even further, in some embodiments, individuals can be identified using payment information such as their credit card number or the name associated with their credit card. In further embodiments, individuals can be identified by loyalty accounts or through other rewards programs. Notably, when sensitive data (such as credit card information) is stored in the system, it can be stored using a hash function to generate an associated hash value that can be used to identify the individual without storing sensitive data.

Further, in some embodiments, the different methods to identify an individual can be combined. For example, an image of a person can be associated with a MAC address of a device he or she carries. In some embodiments, these methods can be combined by locating the position of an individual at a venue by using the individual's Wi-Fi signal (for example, with triangulation). Multiple wireless antennas (for example, directional wireless antennas) can be deployed such that the location of the person's device (for example, smartphone) can be identified. The location of the device can then be associated with a camera image from the same location to yield a picture of the same individual. The location of a camera image can be known by using a known position of the camera (for example, if an associated VM device 100 has a GPS module, or of the position is otherwise known). The position of the image relative to the camera can be known using calibration. If there is only one person at the identified location, the image of that person can be associated with the MAC address.

Other forms of data, such as voice and payment information, can also be associated with an individual in a similar manner. For example, cameras directed toward a payment location such as a cashier or checkout line can capture images of a visitor while they are paying. Thus, the payment information can be automatically associated with an image of the person paying at the same time and place.

The various data identifying a particular individual can be combined to generate a profile of the individual. As discussed further herein, such profiles can be used to analyze and develop data regarding the visitors at a venue and provide information, coupons, and other forms of advertisements to particular individuals.

Visual data can be analyzed to identify individuals in a variety of ways. For example, in some embodiments, the visual and/or image data can be analyzed by computers associated with the VM device 100. These computers or servers can be on-site, at the venue, or at a remote location. In some embodiments, algorithms can be used to automatically identify the individuals by their images in real-time.

The algorithms optionally can be developed using machine learning techniques such as artificial neural networks. For example, the algorithm can be taught using multiple images or videos that are already known to include people. The computer can then be trained to identify whether the image or video includes a person or does not. In further embodiments, the algorithm can be trained to identify additional characteristics such as how many people are present, what the people are doing, and whether people from different images or videos are the same person. Notably, a face might not be visible in many images; therefore, facial recognition cannot always be used to identify individuals.

In some embodiments, a set of images and associated details (such as whether a person is present in the image or what they are doing) can be developed using a set of CAPTCHAs. Images or videos of people taken using the VM devices 100 can be presented to human testers, such as Internet users, as a CAPTCHA. If multiple testers identify an image or video as including a person, showing a person doing a particular action, or similar characteristics, the group consensus can be used to verify the validity of the result. More specifically, in some embodiments, a portion of the image can be specified and a tester can be asked if that specified portion includes a person (or if the person is performing a particular action). It will be understood that similar techniques can be used with video or audio to train a machine-learning algorithm.

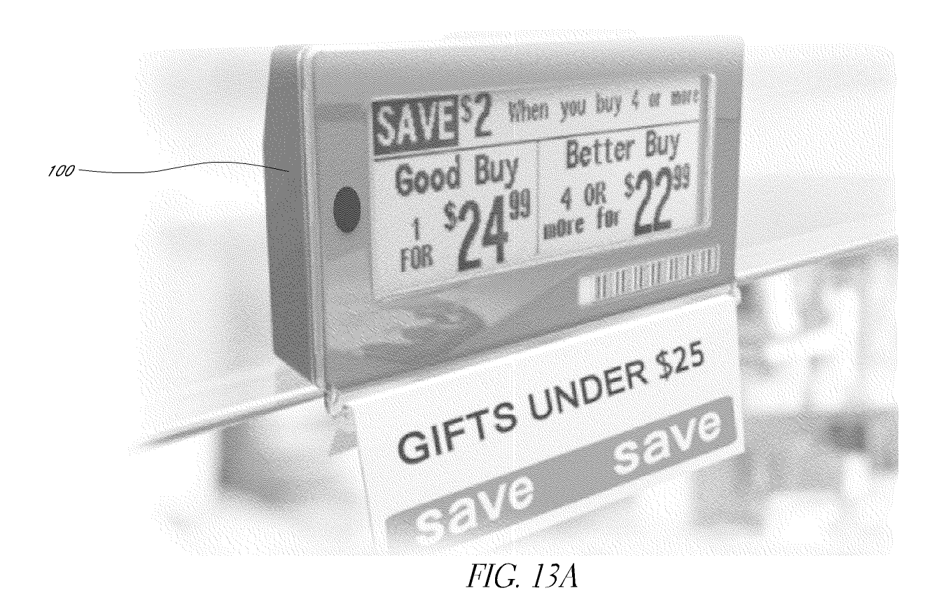

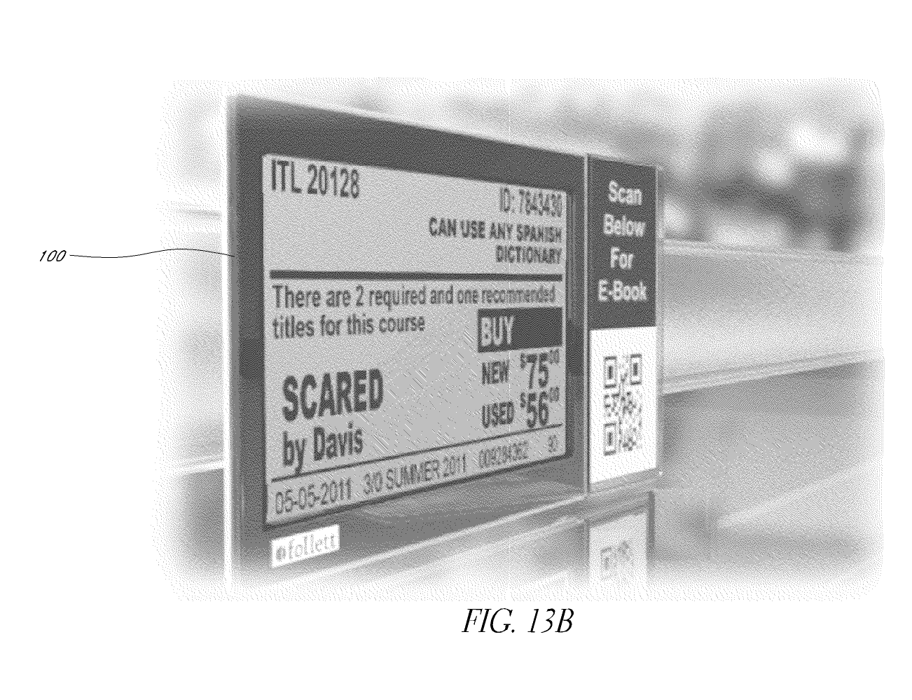

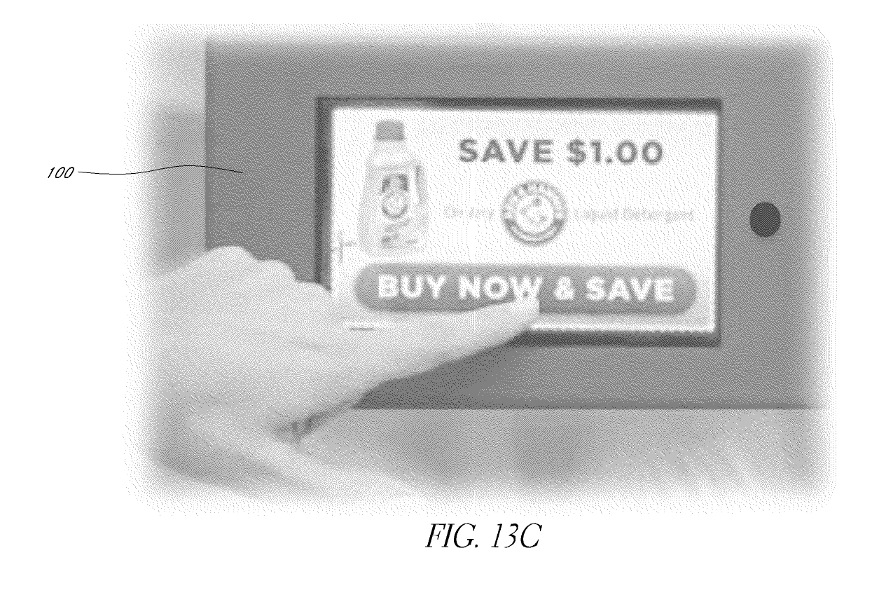

In further embodiments, VM devices 100 can also be used as smart labels in some venues (for example, retail) to form a smart label system. As shown in FIGS. 13A-13C, the VM device 100 can have a general small cubic shape or be box-like, including a display screen, a camera, and other features. The screen can be used to display information about a particular product, such as a product on the shelves. For example, the screen might display the name, price, and other details about a particular item. Advantageously, when items and/or prices are changed, the screen can be easily updated electronically through electronic communications between the VM devices used as smart labels and a separate computer system. In some embodiments, prices can then be updated frequently (for example, daily or hourly) according to changing demand, supply, promotions, or other factors. In some embodiments, short-term sales on one or more items can be started and/or ended automatically through such electronic communications without an individual to manually updating labels throughout the venue.

Further, when the VM device 100 is used as a smart label, it can also provide interactive information to a visitor. For example, if the VM device 100 includes a touchscreen, a visitor can interact with it to acquire additional information such as nutritional facts related to food, similar items the visitor might also want to purchase, and other related information. The VM device 100 can also allow a visitor to request assistance so that an employee at the venue can be paged to a particular location to assist the visitor and to answer specific questions the visitor has.

In even further embodiments, the VM device 100 used as a smart label can provide auditory information to a visitor. For example, the information described herein can be provided in audio. In some embodiments, this can be provided when requested by a visitor, either by interaction with a touchscreen on the device, a vocal request received by a microphone on the device, or other methods.

Further, as discussed above, a person near the relevant smart label potentially can be identified. Based on certain information about the visitor (for example, previous purchase history), discounts, coupons, specifically tailored information about the product, or other product attributes can be displayed to the visitor. In some embodiments, this information can be delayed so that incentives such as a discount or coupon are only provided if the user does not immediately take the relevant sale item off the shelf. These operations can be performed automatically, in real-time, for every visitor in the venue.

Additionally, the positioning of VM device 100 as a smart label can have various benefits. The smart label can be positioned to easily identify a visitor directly in front of it (for example, by using image or Wi-Fi data). If the visitor is directly in front of the smart label and remains in that position for an extended period of time, that visitor can be identified as someone potentially interested in the product at that same position. Product interest can also be identified if the visitor interacts with the smart label, takes an item off the shelf, or other relevant actions. Further, as discussed herein, the interested visitor can be identified, and the visitor's interest in various items and his or her ultimate purchase, can be tracked and combined into a single profile that can be stored and used.

Additionally, cameras placed on a VM device 100 positioned as a smart label can monitor the status of other items. For example, when not obscured by a visitor, the VM device 100 can view items on an opposite side of a shopping aisle. With a greater distance and a different angle, a VM device 100 on the opposite side of an aisle might provide a better view of the actions taken by a visitor viewing the relevant items. Thus, data can be combined to better identify the visitor's actions.

Even further, in some embodiments, a VM device 100 can view the inventory of particular items on a shelf. For example, the device can capture images indicating if all items of a particular type on a shelf have been removed. In such an event, a signal can be sent to a worker at the venue indicating the relevant shelf should be restocked. Further, in some embodiments, this information can also be sent to inventory management systems or relevant workers indicating that more of an item should be ordered from suppliers. Notably, this can be done automatically in real-time, allowing items to be restocked faster than they would be if inventory were observed by a person.

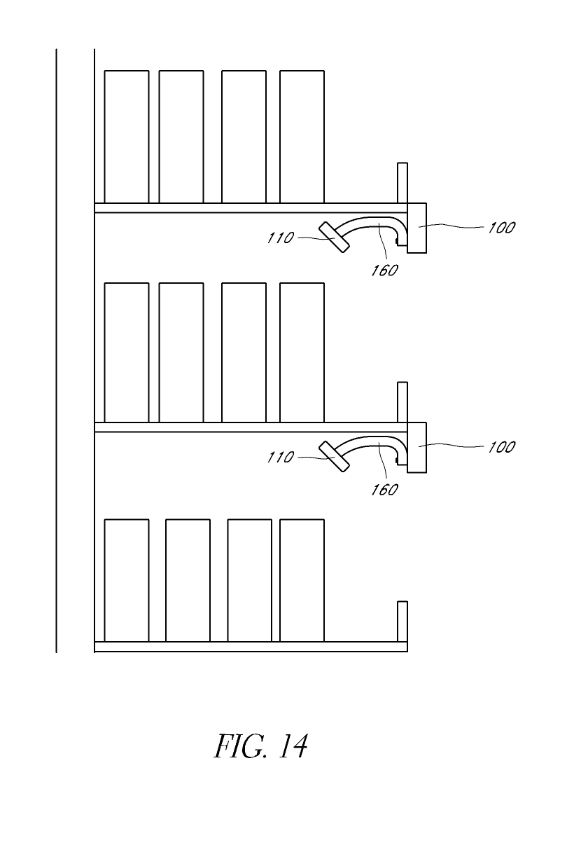

In some embodiments, inventory on a given shelf can be identified using images from a VM device 100 (for example, a smart label device) on an opposite side of an aisle. In other embodiments, the VM device 100 can include a camera (such as an eyestalk) within a shelf, as shown in FIG. 14, so that the device can see how many items are on a shelf even if the items are lined-up such that the quantity can't be determined when viewed from across the aisle. In such embodiments, the precise quantity of items on each shelf can be transmitted to the systems discussed herein.

Advantageously, combining this information with real-time sales data can allow the system to track inventory from the shelf to the point-of-sale in real-time. In some embodiments, a loss of inventory (for example, by theft or destruction) can be discovered by comparing the reduced inventory on store shelves with the sales at approximately the same time. If the reduced inventory does not match the sales, some form of loss and the approximate time of its occurrence can be indicated to a user. When image data is stored, the system can identify a particular person who picked-up a lost item during a similar time period, identifying an individual who might have caused the loss.

Additionally, the VM device 100 can be used for planogram compliance, particularly when positioned as a smart label. The visual data from the VM device 100 can be used to determine various aspects about product positioning and placement. For example, the device can determine if the product is facing the correct direction, if it is oriented correctly (for example, not upside down or label facing the customer), if an ideal quantity of product is present, or if the products are placed on the correct shelves or racks. Further, in some embodiments the VM device 100 and associated systems can alert a worker at a venue when items are not in planogram compliance so that corrections can be made in real-time.

Further, in some embodiments, the VM device 100 can be configured to provide information to a visitor about other available products at the venue. For example, the camera on the VM device 100 can act as a barcode reader so that a visitor can receive information about products from another part of the store. Even further, in some embodiments, image recognition can be used to identify a product without use of a barcode. Even further, in some embodiments, information about the product can be requested by identifying the product using a touchscreen or providing auditory or voice commands to the VM device 100.

There are many different applications of the VM device 100, systems including multiple VM devices, and associated methods; many other applications also can be developed using the VM device 100 with provided software and software in the cloud. Further, different VM devices 100 are described herein with varying features and functionalities. These features and functionalities can be combined in numerous ways to form additional VM devices 100, and said additional combinations are also considered part of this disclosure.

The aforementioned description and drawings represent the preferred embodiments of the present invention, and are not to be used to limit the present invention. For those skilled in the art, the present invention can be modified and changed. Without departing from the spirit and principle of the present invention, any changes, replacement of similar parts, or improvements should all be included in the scope of protection of the present invention. For example, the VM device 100 has been described as a visual monitoring device. However, in some embodiments the device can potentially not include a camera or other visual sensor. Thus, more general visitor monitoring devices can be provided, using audio, Wi-Fi, or other sensors to monitor and detect the presence of visitors, without necessarily including a visual sensor.

1. A system for automatic visitor monitoring and grouping individuals, comprising:
one or more electronic sensors configured to automatically generate sensor data regarding visitors at a venue; and
a processor configured to process the sensor data to identify the physical presence of one or more visitors at a venue, to identify one or more behavioral characteristics of one or more visitors at the venue or characteristics of mobile electronic devices carried by one or more visitors, and to determine if two or more visitors are part of a single group unit.

2. The system for automatic visitor monitoring and grouping individuals of claim 1, wherein the processor is configured to identify if two or more visitors at the venue arrive at the same time to determine if an individual visitor is part of a single group unit.

3. The system for automatic visitor monitoring and grouping individuals of claim 1, wherein the processor is further configured to identify if two or more visitors are in close physical proximity or contact to determine if an individual visitor is part of a single group unit.

4. The system for automatic visitor monitoring and grouping individuals of claim 1, wherein the one or more electronic sensors comprises a camera.

5. The system for automatic visitor monitoring and grouping individuals of claim 1, wherein one or more electronic sensors comprises a Wi-Fi antenna.

6. The system for automatic visitor monitoring and grouping individuals of claim 5, wherein the processor is further configured to identify two or more mobile electronic devices that search over Wi-Fi for the same service set identifier (“SSID”), and to identify these mobile electronic devices as part of the same group unit.

7. The system for automatic visitor monitoring and grouping individuals of claim 1, wherein the processor further comprises a memory and is configured to identify and store in its memory if two or more individual visitors are part of a single group unit.

8. The system for automatic visitor monitoring and grouping individuals of claim 1, wherein the processor is configured to identify an individual visitor based on at least one of an image, a media access control (“MAC”) address, payment information, or an individual's name.

9. The system for automatic visitor monitoring and grouping individuals of claim 1, further comprising a server comprising one or more networked computers at one or more locations and the server being configured to store data generated from the electronic sensors.

10. A method for automatically monitoring and grouping individuals, the method comprising:
monitoring individual visitors at a physical venue using electronic sensors and automatically generating associated electronic sensor data;
processing the electronic sensor data to identify the physical presence of one or more visitors at the venue; and
analyzing one or more behavioral characteristics of the visitors or characteristics of mobile electronic devices carried by the visitors to determine if two or more visitors are members of a single group unit.

11. The method for automatically monitoring and grouping individuals of claim 10, wherein the step of processing the electronic sensor data to identify the physical presence of one or more visitors at the venue comprises identifying substantially all visitors physically present at the venue.

12. The method for automatically monitoring and grouping individuals of claim 10, wherein the step of analyzing one or more behavioral characteristics of the visitors or characteristics of mobile electronic devices carried by the visitors to determine if two or more visitors are members of a single group unit further comprises identifying if two or more visitors arrive at the venue at a same time.

13. The method for automatically monitoring and grouping individuals of claim 10, wherein the electronic sensor data comprises images of one or more visitors.

14. The method for automatically monitoring and grouping individuals of claim 13, the method further comprising the step of storing at least one electronic image of two or more visitors who are identified as part of a single group unit.

15. The method for automatically monitoring and grouping individuals of claim 10, wherein the step of monitoring individual visitors at a physical venue further comprises monitoring Wi-Fi signals from two or more mobile electronic devices at the venue.

16. The method for automatically monitoring and grouping individuals of claim 15, wherein the step of analyzing one or more behavioral characteristics of the visitors or characteristics of the mobile electronic devices carried by the visitors to determine if two or more visitors are members of a single group unit further comprises identifying two or more mobile electronic devices that search over Wi-Fi for the same SSID.

17. The method for automatically monitoring and grouping individuals of claim 10, the method further comprising the step of storing a MAC address for a mobile electronic device associated with a respective visitor.

18. The method for automatically monitoring and grouping individuals of claim 10, the method further comprising the step of storing payment information of two or more visitors who are identified as part of a single group unit.

19. The method for automatically monitoring and grouping individuals of claim 10, the method further comprising the step of analyzing the at least one electronic image to determine if two or more visitors are in close physical proximity or contact and determining if the visitors are part of a single group unit.

20. A method for analyzing images to identify individual visitors, the method comprising:
collecting a large number of electronically generated images or videos with a plurality of images containing one or more persons;
using the images or videos as part of a Completely Automated Public Turing Test to tell Computers and Humans Apart (“CAPTCHA”);
requiring users to identify at least one of if at least one person is present in the image or video, if a person is located at a particular venue, or if a person is performing a particular action; and
using responses generated from the CAPTCHA to train an adaptive computer program product to identify at least one of if at least one person is present in the image or video, if a person is located at a particular venue, or if a person is performing a particular action.

21. A method for identifying multiple aspects of a single visitor, the method comprising:
using a camera to generate an electronic image of the visitor;
identifying the location of the visitor at the time the image is taken based at least in part on a position and orientation of the camera;
using at least one other electronic sensor to verify a visitor's presence at the same location and time as the image is taken; and
associating the image and data from the at least one other electronic sensor to another image in an electronic database of visitor images.

22. The method for identifying multiple aspects of a single visitor of claim 21, wherein at least one other electronic sensor comprises at least one Wi-Fi antenna, and wherein the location of the visitor can be identified using a Wi-Fi signal from a mobile electronic device associated with the visitor.

23. The method for identifying multiple aspects of a single visitor of claim 22, wherein the step of using at least one other electronic sensor to verify a visitor's presence at the same location and time as the image is taken comprises identifying a MAC address unique to the mobile electronic device.

24. The method for identifying multiple aspects of a single visitor of claim 21, wherein at least one electronic sensor to verify a visitor's presence comprises a payment information device, wherein the location of the visitor can be identified as the same location of the payment information device.

25. The method for identifying multiple aspects of a single visitor of claim 24, wherein the payment information device comprises a credit or debit card payment device.

26. The method for identifying unique characteristics of a single visitor of claim 21, wherein the step of using at least one other electronic sensor to identify a visitor's presence at the same location and time as the image was taken comprises using payment information associated with the visitor.

27. The method for identifying unique characteristics of a single visitor of claim 26, wherein the payment information is a credit card number.

28. The method for identifying unique characteristics of a single visitor of claim 26, wherein the payment information is stored securely in the form of a cryptographic hash function.

29. A power-harvesting device, comprising:
a chipset disposed in a housing;
a camera attached to the housing and configured to view one or more visitors in a venue;
a Wi-Fi module disposed within the housing and configured to communicate wirelessly with a server; and
a track-light mounting configured to attach the housing to a continuous track-light fixture.

30. The power-harvesting device of claim 29, the device further comprising electrical conductors.

31. The power-harvesting device of claim 30, wherein the electrical conductors comprise heat-conducting metallic plates.

32. The power-harvesting device of claim 29, further comprising power transformers.

33. A smart labeling system comprising:
a plurality of products disposed in a retail space;
a plurality of smart labels arranged in close physical proximity to associated products such that a specific smart label can provide information to a visitor about a specific product with which it is in close physical proximity, the smart labels comprising:
a display configured to present visual information to a visitor; and
a processor configured to update information presented on the display and communicate with a server configured to communicate with and control the smart labels.

34. The smart labeling system of claim 33, wherein the displays comprise touch screens, and the smart labels are configured to provide a user interface such that a visitor can cause different information to appear on the display by touching the screen.

35. The smart labeling system of claim 33, wherein the server comprises one or more networked computers at one or more locations and is configured to update the information displayed on the smart labels.

36. The smart labeling system of claim 33, wherein the smart labels further comprise a speaker, and are configured to relay auditory information to a visitor.

37. The smart labeling system of claim 33, wherein the server and at least one of the smart labels are configured to detect if the specific product is in compliance with an associated planogram.

38. The smart labeling system of claim 33, wherein the smart labels further comprise one or more electronic sensors configured to identify a visitor.

39. The smart labeling system of claim 38, wherein the smart labels are configured to display different information on a display in response to a visitor remaining in close physical proximity to the electronic sensors for an extended period of time.

40. The smart labeling system of claim 38, wherein the smart labels are configured to provide the identified visitor with a unique, targeted content item.

41. The smart labeling system of claim 33, wherein the smart labels further comprise a camera.

42. The smart labeling system of claim 41, wherein the smart labels are configured to monitor the inventory of a particular product using the camera.

43. The smart labeling system of claim 42, wherein the smart labels are configured to monitor the inventory of a product on the opposite side of an aisle relative to the location of the smart label in the retail space.

44. The smart labeling system of claim 41, wherein the smart labels are configured to scan a barcode or other portion of a product to identify the product and to relay product information to a visitor.

45. The smart labeling system of claim 33, wherein the smart labels further comprise a Wi-Fi antenna.

46. The smart labeling system of claim 33, wherein the smart labels further comprise a microphone capable of receiving voice commands and displaying relevant information in response to the voice commands.
